(19) United States
(12) Patent Application Publication
(10) Pub. No.: US 2026/0024701 A1
(43) Pub. Date: Jan. 22, 2026

(54) METHODS AND SYSTEMS FOR CAPACITOR IMPREGNATION

(71) Applicant: ZAP ENERGY, INC., Everett, WA (US)

(72) Inventors: Scott Douglas Korlann, San Diego, CA (US); Micki Eliezer Acks, San Diego, CA (US)

(21) Appl. No.: 19/271,525

(22) Filed: Jul. 16, 2025

Related U.S. Application Data
(60) Provisional application No. 63/674,210, filed on Jul. 22, 2024.

(51) Int. Cl. H01G 4/22; H05H 1/06

(52) U.S. Cl. CPC H01G 4/221; H05H 1/06

(57) ABSTRACT

Methods and systems are provided for impregnating capacitors and other receptacles with a fluid. In one example, a system may include a reservoir of a purified fluid to be used to impregnate one or more receptacles and a manifold configured to withstand an internal pressure differential to cause the purified fluid to infiltrate the manifold. The system may further include a convection oven in which the one or more receptacles and the manifold are located when the one or more receptacles are impregnated with the purified fluid.

### CROSS-REFERENCE TO RELATED APPLICATION

The present application claims priority U.S. Provisional Application No. 63/674,210, entitled “METHODS AND SYSTEMS FOR CAPACITOR IMPREGNATION” and filed on Jul. 22, 2024. The entire contents of the above-identified application are hereby incorporated by reference for all purposes.

### FIELD

Embodiments of the subject matter disclosed herein relate to methods and systems for oil impregnation of capacitors, and more particularly for impregnation of capacitors usable in a plasma confinement system.

### BACKGROUND

The “holy grail” of harnessing cheap, efficient, and renewable energy is widely considered to lie with production-scale generation of self-sustaining, capturable fusion power or “fusion ignition.” A scalability of this source of energy may be limited, at least in part, by an ability to manufacture and prepare various components and equipment used to facilitate and sustain formation of a plasma providing ions for fusion. For example, power sources used to generate a potential difference between electrodes of a fusion ignition system may include a bank of capacitors. Prior to implementation in the fusion ignition system, the capacitors may be prepared by impregnation with an impregnation fluid, such as an oil or a dielectric, to displace air therein and regulate capacitor temperature during operation of the fusion ignition system. Impregnation of the capacitors with the impregnation fluid, however, is a lengthy process with low throughput.

### BRIEF DESCRIPTION OF THE DRAWINGS

Various embodiments and techniques will be described with reference to the drawings, in which:

FIG. 1 shows a schematic diagram of an impregnation system for impregnating one or more capacitors with an impregnation fluid, in accordance with at least one embodiment;

FIGS. 2-15 show various operational stages of the impregnation system of FIG. 1 or a portion thereof, in accordance with at least one embodiment;

FIG. 16 shows a side view of a double-threaded fitting used to fluidically couple a capacitor to a manifold of the impregnation system of FIGS. 1-15, in accordance with at least one embodiment;

FIG. 17 shows a cross-sectional view of the double-threaded fitting of FIG. 16, in accordance with at least one embodiment;

FIG. 18 shows a perspective view of a capacitor cover that includes the double-threaded fitting of FIGS. 16-17, in accordance with at least one embodiment;

FIG. 19 shows a perspective view of a capacitor that includes the capacitor cover of FIG. 18, in accordance with at least one embodiment;

FIG. 20 shows a block diagram of a method for purifying an impregnation fluid to be used to impregnate one or more capacitors, in accordance with at least one embodiment;

FIG. 21 shows a block diagram of a method for impregnating one or more capacitors with a purified impregnation fluid, in accordance with at least one embodiment;

FIG. 22 shows a schematic cross-sectional diagram of a plasma confinement system, in accordance with at least one embodiment;

FIG. 23 shows a block diagram of a method for operating a plasma confinement system, for example, by initiating and driving a sheared ion velocity flow therein for stabilization of a Z-pinch discharge, in accordance with at least one embodiment;

FIGS. 24A-24F show schematic cross-sectional diagrams of a process of initiating and driving a sheared ion velocity flow in the plasma confinement system of FIG. 22 for stabilization of a Z-pinch discharge, in accordance with at least one embodiment;

FIG. 25 shows a schematic cross-sectional diagram of a plasma confinement system, in accordance with at least one embodiment; and

FIG. 26 shows a block diagram of a method for operating a plasma confinement system, in accordance with at least one embodiment.

### DETAILED DESCRIPTION

Techniques described and suggested herein include a system, which may include a reservoir of a purified fluid to be used to impregnate one or more receptacles and a manifold fluidically coupled to the one or more receptacles and the reservoir, the manifold configured to withstand an internal pressure differential (e.g., between the reservoir and the manifold) that is to cause the purified fluid to infiltrate the manifold. The system may further include a convection oven in which the one or more receptacles and the manifold are located when the one or more receptacles are impregnated with the purified fluid.

In at least one embodiment, a system for assembling one or more capacitors may include a first subsystem to purify a fluid to be used to impregnate the one or more capacitors and a second subsystem to receive the fluid from the first subsystem. The second subsystem may also be used to impregnate the one or more capacitors with the fluid (e.g., in parallel) via a manifold configured to withstand an internal pressure differential to cause the fluid to infiltrate the manifold from the first subsystem. The manifold may be positioned within a convection oven.

In at least one embodiment, a method may include coupling one or more receptacles to a manifold and impregnating the one or more receptacles with a fluid (e.g., prepared to be used for the impregnation) by varying internal pressure at the manifold. The method may further include sealing the one or more receptacles while the one or more receptacles remain coupled to the manifold.

In at least one embodiment, a system may include a capacitor, including a capacitor body at least partially enclosing an interior volume impregnated with a purified fluid, a cover coupled to the capacitor body, a fitting coupled to the cover and protruding away from the interior volume, and a threaded cap coupled to the fitting. The fitting may include a first set of threading disposed at an outer surface of the fitting and a second set of threading disposed at an inner surface of the fitting.

These, as well as other aspects, advantages, and alternatives will become apparent to those of ordinary skill in the art by reading the following detailed description, with reference where appropriate to the accompanying drawings. Further, it should be understood that descriptions and figures provided herein are intended to illustrate the invention by way of example only and, as such, that numerous variations are possible.

For example, the following description relates to various embodiments of systems and methods for impregnating one or more devices with an impregnation fluid in a readily scalable manner. In at least one embodiment, the impregnation may be achieved via an impregnation system including a manifold through which a range of pressures may be applied to the one or more devices coupled thereto to be impregnated. The manifold may further deliver the impregnation fluid to the one or more devices to fill the one or more devices with the impregnation fluid. In at least one embodiment, the one or more devices may be one or more capacitors, and the impregnation fluid may be an oil. In at least one embodiment, the oil may be a dielectric. For example, a vacuum, or near vacuum, pressure may be conveyed to the one or more capacitors through the manifold, which may further provide a channel to transfer the oil to the one or more capacitors from a purified source of the oil that can be assisted with back pressure greater than atmospheric pressure.

In at least some instances, the capacitors may be implemented in a high energy system or device. For example, the high energy system or device may include a medical device, an electric vehicle, and/or various types of power systems, among others. In at least one embodiment, the high energy system or device may include a plasma confinement system, as described herein, such as a magnetic plasma confinement system or an inertial plasma confinement system. In yet other embodiments, the capacitors may be high energy capacitors configured to deliver sub-second pulses of output current for medical applications, such as x-ray imaging, equipment sterilization, or cardiac defibrillation, defense applications, such as plasma ignition for electrothermal chemical (ETC) rounds, electromagnetic launch, electromagnetic armor, high power microwaves for active denial, high power microwaves for electronic jamming, or formation of underwater shockwaves. The high energy capacitors may also be used for electromagnetic pulse (EMP) generation, nuclear weapon effects simulation, electromagnetic launching in environments lacking sufficient oxygen for combustion (e.g., cislunar launching), plasma propulsion engines, and industrial manufacturing such as magnetic pulse welding, electrohydraulic forming, lysing cells for sterilization or harvesting oils from algae, and water treatment. Furthermore, the high energy capacitors may also be used for linear accelerators, particle accelerators, DC link capacitors for power conversion, lightning simulation, identification of geologic formations, and proof testing and fault location in underground power cables.

In at least one embodiment, the manifold may be coupled, e.g., fluidically coupled, within the system to an apparatus that prepares an oil for impregnating the capacitors. For example, the apparatus may leverage a variety of conduits and valves to regulate pressure within the apparatus to facilitate purification of the oil and transfer of the purified oil to the manifold. The oil may be prepared and delivered to the capacitors through the manifold according to a simple, low-cost process that reduces energy consumed by the system.

By utilizing the manifold as described herein, in at least one embodiment, a process for impregnating capacitors may be faster and more cost-efficient than other techniques for impregnation that impose constraints on producing capacitors for fusion ignition systems. For example, by moderating internal pressures of the capacitors via the manifold, use of a costly vacuum chamber that is large enough to enclose the capacitors is obviated. Moreover, in at least one embodiment, rather than heating and cooling the capacitors within a vacuum chamber that demands prolonged periods of time to do so because of poor or no convection, pressure control by way of the manifold allows the capacitors' temperatures to instead be regulated more effectively with convection using a convection oven, which may accelerate both heating and cooling of the capacitors.

Furthermore, in at least one embodiment, use of the manifold may be leveraged to reduce and/or minimize a presence of undesirable adsorbed liquids (e.g., water) and one or more gases (e.g., moist air) in the capacitors after impregnation. For example, when the capacitors are decoupled from the variable pressure manifold, ambient humidity and unwanted gases may be introduced into a capacitor unless an airtight seal such as an oil shield is maintained at a coupling port of the capacitor. In at least one embodiment, the presence of adsorbed water and ambient air in the capacitor may be mitigated by a vacuum adaptor that may be installed in a cover of the capacitor. The vacuum adaptor may be, for example, a fitting such as a double-threaded fitting, which may allow a plug or cap to be mated to the double-threaded fitting to seal the capacitor while the double-threaded fitting is at least partially submerged (e.g., fully submerged) under a head layer of the oil, thereby precluding displacement of the oil with air. For example, the double threaded fitting may be used to couple the capacitor to the manifold to facilitate delivery of the oil to the capacitor and allow an excess amount of oil to be maintained at the fitting when impregnation of the capacitor is complete. The capacitor may then be sealed by coupling the plug or cap to the double-threaded fitting under a layer of the oil such that air does not enter through the double-threaded fitting.

The systems and methods, as described herein for impregnating a capacitor with a fluid, may reduce a minimum threshold amount and/or an average amount of time to prepare the capacitor for use in various applications, such as use in a plasma confinement system for fusion ignition. The impregnation may rely on establishment of pressure differentials to prepare the oil and drive the oil into the capacitor, with reduced complexity, costs, and equipment footprint. In addition, implementation of a variable pressure manifold to transmit the pressure differentials and, in turn, the fluid, to an internal volume of the capacitor may allow heating, drying, and cooling of the capacitor to be expedited via convection, in contrast to systems where the capacitor would instead be heated, dried, and cooled within a vacuum chamber. Moreover, the manifold and vacuum system as well as the device providing convectional heating and cooling, may be scaled up as demanded to increase throughput without introducing barriers such as added complexity or space or prohibitively augmented costs.

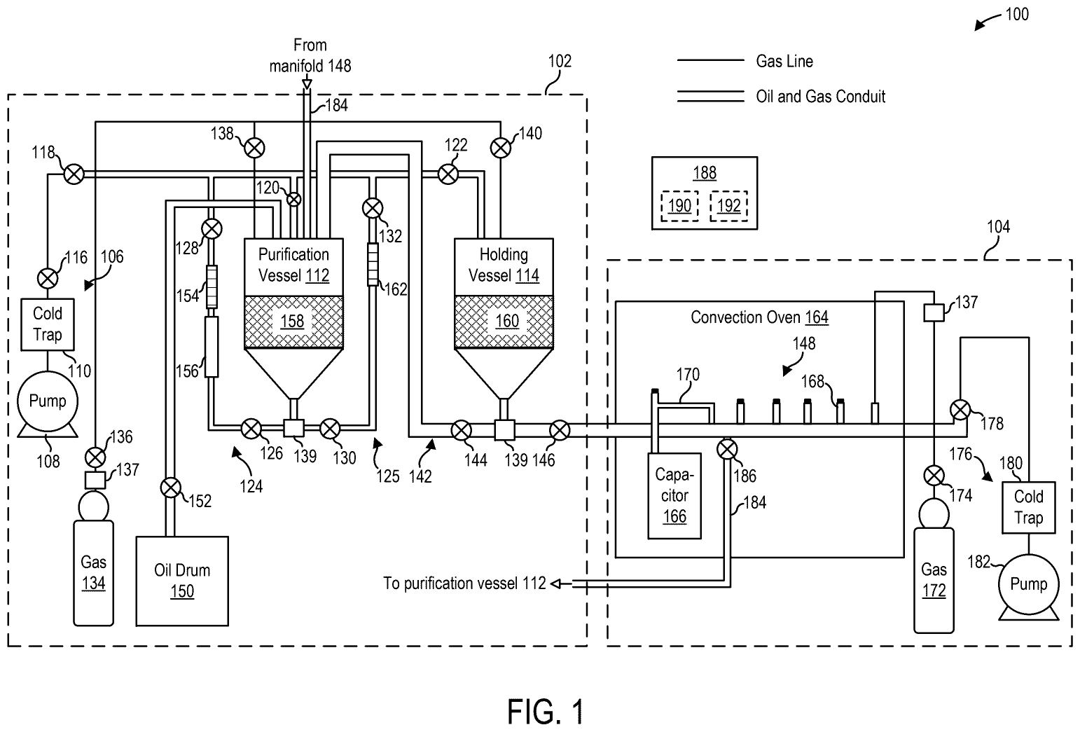

In additional, alternative, or otherwise modified embodiments to those described above and in detail below with reference to FIGS. 1-21, one or more components of the impregnation system may be added, removed, substituted, modified, or interchanged to adapt the impregnation system for a given use case. As an example, capacitors impregnated as described herein may be used in systems other than for plasma confinement. Further, though various embodiments described herein are discussed with reference to impregnating capacitors, other devices requiring drying and impregnation with a fluid may be similarly filled using the impregnation system. In addition, although the discussion herein is focused on the impregnation of devices or receptacles with a fluid such as an oil or a dielectric, other fluids may be used in a similar manner to achieve impregnation of the devices or receptacles.

Referring now to FIG. 1, an embodiment of an impregnation system 100 is depicted. In at least one embodiment, the impregnation system 100 may be used to assemble one or more receptacles with a fillable internal volume, such as a capacitor, by impregnating the one or receptacles with an impregnation fluid. As described herein, impregnating a receptacle may refer to filling an internal volume of the receptable, transferring the impregnation fluid into the receptacle, flowing the impregnation fluid in the receptacle, or otherwise adding or infiltrating the impregnation fluid to the receptacle to at least partially fill the internal volume of the receptacle with the impregnation fluid. In at least one embodiment, impregnating the receptacle may be synonymous, or nearly synonymous, with infusing the receptacle with a fluid. The impregnation fluid, in at least one embodiment, may be an electrically insulating fluid that can be polarized by an exposure to an electric field, such as an oil. In the exemplary embodiment where the device to be impregnated is a capacitor, the oil may be a dielectric.

The impregnation system 100 may include a first portion 102, at which an impregnation fluid, e.g., an oil, may be treated in preparation for impregnation, and a second portion 104, at which one or more receptacles may be prepared for impregnation and then filled with the oil. In at least one embodiment, the first portion 102 may be a first subsystem of the impregnation system 100 used to purify a fluid (e.g., the oil) to be used to impregnate one or more capacitors and the second portion 104 may be a second subsystem of the impregnation system 100 used to receive the (purified) fluid from the first portion 102 and to impregnate the one or more capacitors with the fluid (e.g., via a manifold configured to withstand an internal pressure differential sufficient to cause the fluid to infiltrate the manifold from the first portion 102). Hereafter, the first portion 102 may be referred to as a purification portion 102, and the second portion 104 may be referred to as an impregnation portion 104. The purification portion 102 and the impregnation portion 104 may be coupled (e.g., fluidically coupled) to one another by one or more conduits, as indicated in FIG. 1.

Furthermore, various components within the purification portion 102 and within the impregnation portion 104 may be fluidically coupled to one another through a variety of gas lines (illustrated as single lines) and conduits (illustrated as pairs of lines) and valves, as described below. The gas lines may deliver vapor-phase materials and communicate pressures therethrough via, for example, pressure regulators 137, and the conduits may, in addition to channeling vapor-phase materials and changes in pressure, flow the oil therethrough. The valves and/or pressure regulators 137 may be adjusted between closed and open positions, where, in some instances, the open positions may include a continuous range of increasingly open positions up to a maximum opening of the valves. Flow through the valves may thereby be controlled by adjusting an extent of the opening of the valves and/or through the pressure regulators 137. In other examples, the valves may be adjusted between a closed position and an open position where the open position includes a single position that allows flow through the valves. The valves are depicted in FIGS. 1-15 as a circle with either a “+” symbol or a “×” symbol inside the circle. When illustrated as an encircled “+” symbol, the respective valve is indicated to be open, which may include the valve being in a fully open or at least partially open position (e.g., more open than the closed position). When illustrated as an encircled “×”, the respective valve is indicated to be closed (e.g., flow through the valve is blocked). In at least one embodiment, the valves may normally be in the closed position (e.g., the closed position may be a default state of the valves) until adjusted open, either electronically, such as by a controller, and/or manually, such as by an operator.

In at least one embodiment, the purification portion 102 may include a first pump assembly 106, which may include a first vacuum pump 108 coupled to a first cold trap 110 that is arranged upstream of the first vacuum pump 108. In other embodiments, however, a ballast may be used instead of the first cold trap 110, to extract water from vapors incoming to the first vacuum pump 108. Removal of the water prior to reception at the first vacuum pump 108 may prolong a useful life of the first vacuum pump 108 and reduce degradation of pump oil lubricating the first vacuum pump 108. The first pump assembly 106 may be fluidically coupled to a purification vessel 112 and a holding vessel 114 through one or more gas lines and conduits, a first valve 116, a second valve 118, a third valve 120, and a fourth valve 122. The purification vessel 112 may be a reservoir for receiving unpurified oil and may be fluidically coupled to a recirculation circuit 124 that is also fluidically coupled to a flow path communicating vacuum from the first pump assembly 106 to the purification vessel 112 and the holding vessel 114. The recirculation circuit 124 may include a fifth valve 126 and a sixth valve 128. The holding vessel 114 may be a reservoir for storing the oil once the oil is purified and is fluidically coupled to the purification vessel 112 through a vessel transfer flow path 125 that includes a seventh valve 130, an eighth valve 132, as well as the fourth valve 122. Accordingly, in an example embodiment, the purification vessel 112 may be a reservoir of a fluid prior to purification. In an additional or alternative embodiment, the holding vessel 114 may be a reservoir of a purified fluid, e.g., to be used to impregnate one or more receptacles, wherein the holding vessel 114 is to receive the fluid from the purification vessel 112 after the fluid is purified. For example, the fluid may be transferred from the purification vessel 112 to the holding vessel 114 by an internal pressure differential generated between the purification vessel 112 and the holding vessel 114.

In least one embodiment, the purification portion 102 may further include a first gas supply 134, which may be, for example, one or more reservoirs of one or more inert gases, such as nitrogen, argon, or dry compressed air. The first gas supply may be fluidically coupled to the purification vessel 112 and the holding vessel 114 by gas lines, a ninth valve 136, a tenth valve 138, and an eleventh valve 140. The purification portion 102 may be fluidically coupled to the impregnation portion 104 of the impregnation system 100 by a main conduit 142 that includes a twelfth valve 144 and a thirteenth valve 146. The main conduit 142 may fluidically couple the purification vessel 112 and the holding vessel 114 to a variable pressure manifold 148 (e.g., a vacuum manifold) of the impregnation portion 104. In at least one embodiment, the variable pressure manifold 148 may communicate a range of pressures, including pressure above and below ambient pressure, to components (e.g., capacitors or other receptacles) fluidically coupled thereto, and may additionally deliver fluids therethrough. For example, the variable pressure manifold 148 may be configured to withstand an internal pressure differential between the holding vessel 114 and the variable pressure manifold 148 that is to cause a purified fluid to infiltrate the variable pressure manifold 148. In at least one embodiment, the main conduit 142 may allow the oil to be returned from the holding vessel 114 to the purification vessel 112 when the twelfth valve 144 is open (with the pressure in the impregnation system 100 adjusted accordingly) and the thirteenth valve 146 is closed to, for example, facilitate additional purification of the oil. Alternatively, when the twelfth valve 144 is closed and the thirteenth valve 146 is open, and the pressure adjusted accordingly, the oil may flow from the holding vessel 114 into the variable pressure manifold 148.

In at least one embodiment, the purification portion 102 may also include an oil reservoir 150. For example, the oil reservoir 150 may be an oil drum 150. The oil drum 150 may be fluidically coupled to the purification vessel 112 through a conduit and a fourteenth valve 152. Preparation and purification of the oil that is stored in the oil drum 150 may thereby be performed by adjustment of the valve positions to modify pressures in selected portions of the purification portion 102 to facilitate flow of the oil from the oil drum 150, into the purification vessel 112, through the recirculation circuit 124, and into the holding vessel 114 to store the purified oil until impregnation of one or more capacitors is initiated.

In at least one embodiment, the purification portion 102 may include various additional components to aid in purifying the oil. For instance, the recirculation circuit 124 may include one or more first filters 154. In at least one embodiment the first filter 154 may be composed of one or more materials including, but not limited to, aluminum magnesium silicate. For example, the first filter 154 may include Fuller's earth, although other filtration materials are possible. Moreover, in at least one embodiment, the first filter 154 may include one or more subcomponents providing tiered filtration. For example, the first filter 154 may include a first sub-filter that removes particles of 10 μm or greater and a second sub-filter that removes particles of 5 μm or greater. The recirculation circuit 124 may optionally include a recirculation pump 156 that may promote flow and recirculation of the oil through the first filter 154 to remove particulate contaminants from the oil. Additionally, the purification vessel 112 may be adapted with a first heater 158 and the holding vessel 114 may be adapted with a second heater 160. The first and second heaters 158, 160 may be different or similarly configured and may be, for example, a flexible heating mantle, a heating coil, or some other type of heating device. The heaters may be used to increase a temperature of the purification vessel 112 and the holding vessel 114, to remove water and other volatile impurities from the oil. Furthermore, the vessel transfer flow path 125 may include a second filter 162, which may include similar or different materials relative to the first filter 154 to provide additional extraction of particulate contaminants. In at least some instances, the second filter 162 may be configured to remove a smaller particulate size than the first filter 154.

In addition, the purification portion 102 may include oil sample chambers 139 positioned proximate to outlets of the purification vessel 112 and the holding vessel 114. The oil sample chambers may allow oil samples to be removed from the purification portion 102 to be analyzed for various parameters, including but not limited to, water content, particulate matter content, as well as measurement of other impurities and contaminants. Although two of the oil sample chambers 139 are depicted in the purification portion 102, other embodiments may include various quantities of the oil sample chambers 139 located in various regions of the conduits of the purification portion 102.

As discussed above, in at least one embodiment, the impregnation portion 104 may receive the purified oil from the purification portion 102. In at least one embodiment, the impregnation portion 104 may include a convection oven 164, which may enclose the variable pressure manifold 148, as well as one or more capacitors 166 or other receptacles coupled to the variable pressure manifold 148 (e.g., when the one or more capacitors 166 are impregnated with the purified oil). The variable pressure manifold 148 may support pressures both below atmospheric pressure and above atmospheric pressure. For example, gaskets and seals of the variable pressure manifold 148 may provide sealing capacity both under vacuum and when pressurized to pressures above atmospheric pressure. The variable pressure manifold 148 may include a plurality of ports 168 to which adaptors 170 may be connected to fluidically couple the one or more capacitors 166 (e.g., in parallel) to the variable pressure manifold 148.

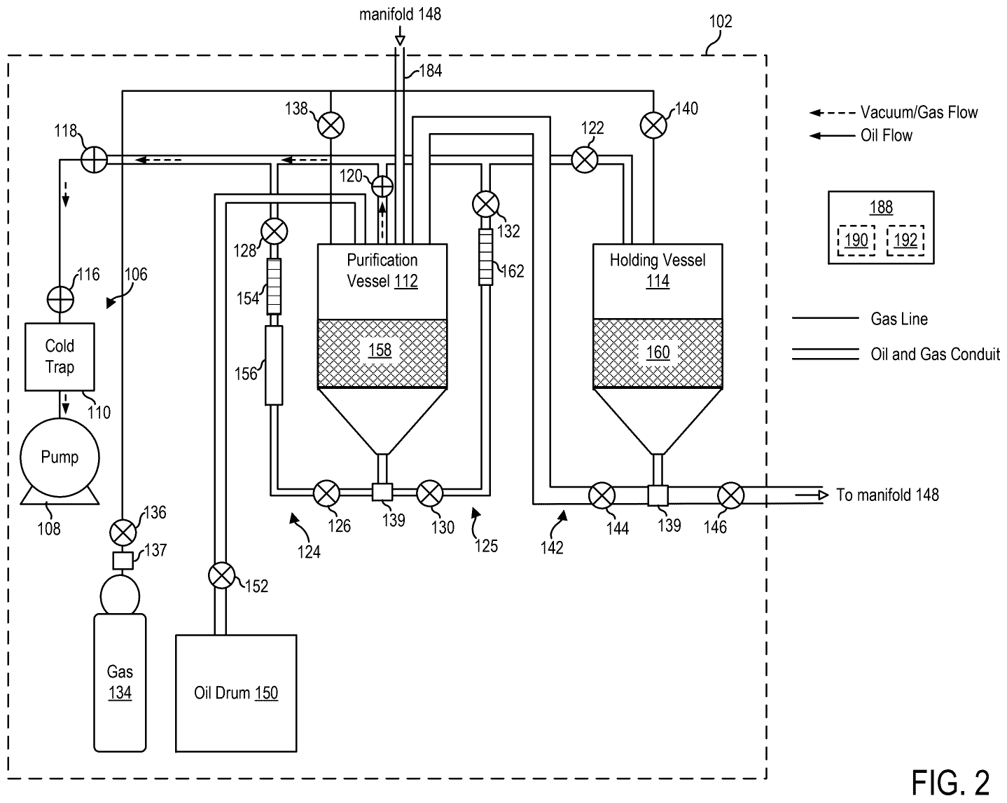

In at least one embodiment, one or more of the adaptors 170 may be connected to the one or more capacitors 166 via a first section (e.g., a first piping section) that extends vertically above the respective capacitor 166 and a second section (e.g., a second piping section) that extends parallel with the variable pressure manifold 148. The second section may be positioned vertically above than the variable pressure manifold 148 and extending to the first section, while the first section may extend vertically below the variable pressure manifold 148 and extending to the capacitors 166 such that the capacitors 166 are positioned vertically below the variable pressure manifold 148 when coupled thereto by the adaptors 170. It will be appreciated that a quantity of the ports 168 depicted in FIG. 1 (as well as throughout FIGS. 2-15) is exemplary and non-limiting, and other numbers of the ports 168 are possible. Furthermore, any number of the ports 168 may be coupled to one of the capacitors 166. As such, the variable pressure manifold 148 may be scaled according to a desired simultaneous throughput of capacitor charging and impregnation. A size of the convection oven 164 may be selected according to a size and/or capacity of the variable pressure manifold 148, as well as one or more capacitors 166 coupled to the variable pressure manifold 148. Alternatively, the size and/or capacity of the variable pressure manifold 148, as well as the one or more capacitors 166 coupled to the variable pressure manifold 148, may be selected according to a given size of the convection oven 164.

In at least one embodiment, the variable pressure manifold 148 may be fluidically coupled to a second gas supply 172 by a gas line and a fifteenth valve 174. The second gas supply 172 and the fifteenth valve 174 may be positioned outside of the convection oven 164. In one example, the second gas supply 172 may include one or more reservoirs of one or more inert gases, such as nitrogen or argon, which may be composed of the same one or more gases as the first gas supply 134. In at least one embodiment, the second gas supply 172 may deliver a gas pressure that is higher than a pressure delivered by the first gas supply 134. As an example, the first gas supply 134 may include one of the pressure regulators 137 that delivers a gas pressure of up to 2 atm, or 29 psi, while the second gas supply 172 may include one of the pressure regulators 137 that delivers a gas pressure of a range of 2-6.8 atm, or 29-100 psi. In other embodiments, however, the second gas supply 172 may provide a pressure range that may be higher than that delivered by the first gas supply 134 but less than 100 psi.

In at least one embodiment, the variable pressure manifold 148 may further be fluidically coupled to a second pump assembly 176 by a gas line and a sixteenth valve 178. The second pump assembly 176 and the sixteenth valve 178 may both be located outside of the convection oven 164. The second pump assembly 176 may include a second cold trap 180 and a second vacuum pump 182. In addition, in at least one embodiment, the variable pressure manifold 148 may be fluidically coupled to the purification vessel 112 by a drain 184 and a seventeenth valve 186.

In at least one embodiment, the impregnation system 100 may include a controller or other computing device 188, which may include non-transitory memory on which executable instructions may be stored. The executable instructions may be executed by one or more processors of the controller 188 to perform various functionalities of the impregnation system 100. Accordingly, the executable instructions may include various routines for operation, maintenance, and testing of the impregnation system 100. The controller 188 may further include a user interface at which an operator of the impregnation system 100 may enter commands or otherwise modify operation of the impregnation system 100. The user interface may include various components for facilitating operator use of the impregnation system 100 and for receiving operator inputs (e.g., requests to generate open or close valves, etc.), such as one or more displays, input devices (e.g., keyboards, touchscreens, computer mice, depressible buttons, mechanical switches other mechanical actuators, etc.), lights, etc. The controller 188 may be communicably coupled to various components of the impregnation system 100 to command actuation and use thereof (wired and/or wireless communication paths between the controller 188 and the various components are omitted from FIG. 1 for clarity). In at least one embodiment, the components may include a variety of sensors 190 for detecting and/or monitoring a status of various parts of the impregnation system 100, including, but not limited to, temperature sensors, pressure sensors, vacuum gauges, humidity sensors, fill level sensors, etc. The components may also include, for example, actuators 192, which may include the valves of the impregnation system 100, switches for energizing pumps, mass flow controllers, switches for energizing heating devices, switches for energizing and adjusting operation of the convection oven 164, etc.

Impregnation of the one or more capacitors 166 with the oil via a low cost and efficient process utilizing the impregnation system 100 depicted in FIG. 1 is now described with respect to FIGS. 2-15. At least some of FIGS. 2-15 show either only the purification portion 102 or only the impregnation portion 104 of the impregnation system 100. When only one portion of the impregnation system 100 is depicted, the components of other portion(s) of the impregnation system 100 that are not shown can be construed as not actively in use (e.g., with all corresponding valves of that portion closed).

The process may begin with purifying the oil. In at least one embodiment, purifying the oil may be initiated, as shown in FIG. 2, by activating the first pump assembly 106 and opening the first valve 116, the second valve 118, and the third valve 120. The purification vessel 112 may be evacuated as indicated by dashed arrows with unfilled heads, the dashed arrows indicating a direction of vacuum-compelled flow of gases through the impregnation system 100. In at least one embodiment, a pressure in the purification vessel 112 may be reduced to 100 mTorr by operation of the first vacuum pump 108, although other pressures are possible such as between 0.05 mTorr to less than 760 mTorr, or 6.6×10⁻⁸ atm to less than 1 atm.

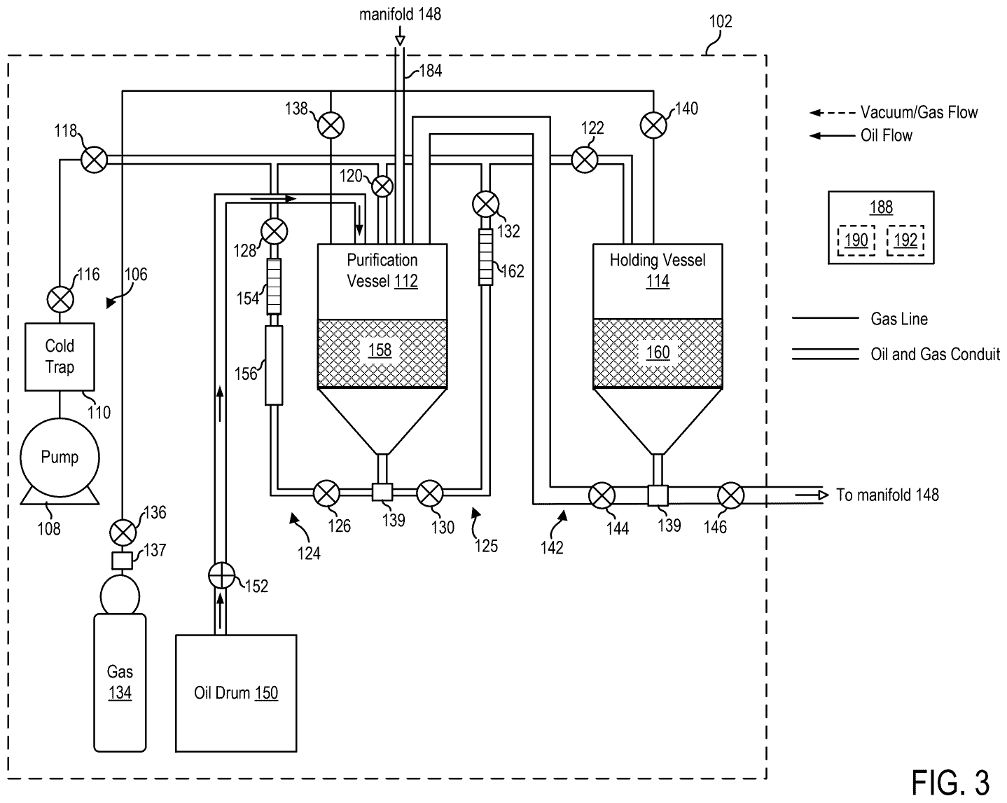

As shown in FIG. 3, once the purification vessel 112 is evacuated to a target pressure within a range of 0.05 mTorr to less than 760 mTorr, or 6.6×10⁻⁸ atm to less than 1 atm, for a desired duration, the first and second valves 116, 118 may be closed and the first pump assembly 106 may be deactivated. In at least some embodiments, however, the first pump assembly 106 may remain in an operating (e.g., active and energized) mode after the first and second valves 116, 118 are closed. The fourteenth valve 152 may be opened to fluidically couple the oil drum 150 to the evacuated purification vessel 112. In at least one embodiment, the oil drum 150 may be an unsealed vessel and may be at atmospheric pressure. A pressure differential between the oil drum 150 and the purification vessel 112 (e.g., higher pressure at the oil drum 150 than the purification vessel 112) may drive flow of the oil from the oil drum 150 into the purification vessel 112, as indicated by solid arrows, where solid arrows depict flow of the oil through the impregnation system 100. In at least one embodiment a volume of the oil stored in the oil drum 150 may be less than an internal volume of the purification vessel 112 and the fourteenth valve 152 may remain open until all (or substantially all) of the oil stored in the oil drum 150 is transferred to the purification vessel 112. In at least one other embodiment, the volume of the oil stored in the oil drum 150 may be greater than the internal volume of the purification vessel 112 and the fourteenth valve 152 may be closed when an amount of the oil transferred into the purification vessel 112 reaches a target fill level of the purification vessel 112.

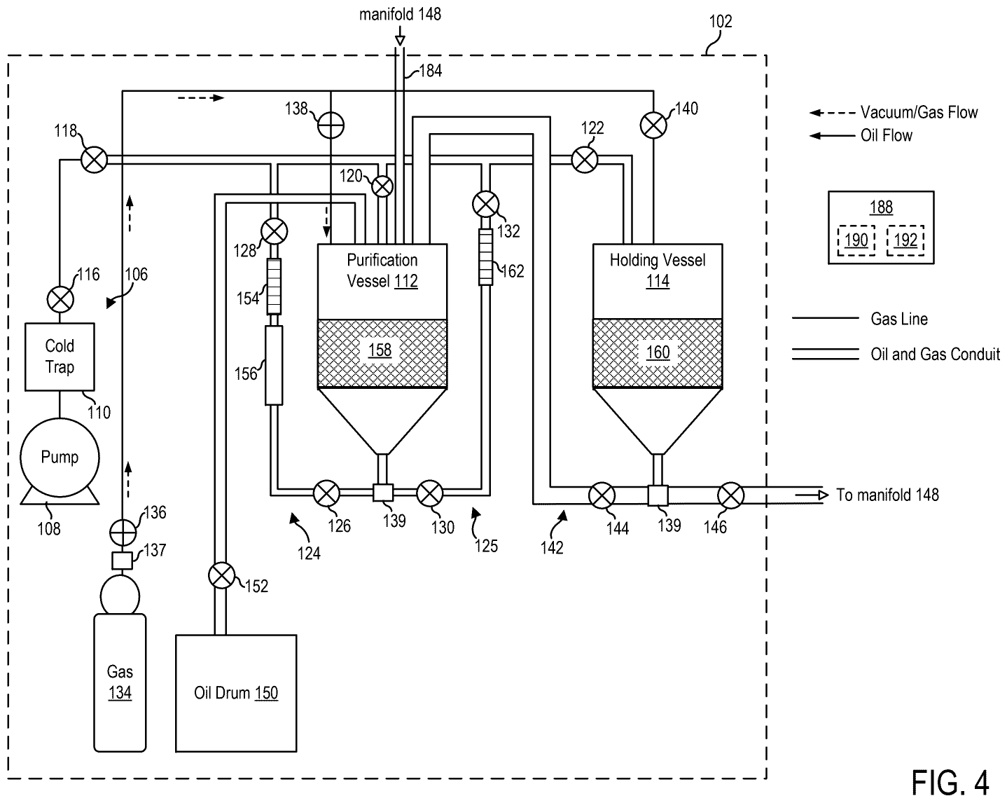

The purification vessel 112 may be repressurized, as shown in FIG. 4, by closing the fourteenth valve 152 (if not already closed), and opening each of the ninth valve 136 and the tenth valve 138 to communicate a pressure regulated by, for example, the pressure regulator 137 or another device for regulating gas flow, of the first gas supply 134 the purification vessel 112. In at least one embodiment, the purification vessel 112 may be repressurized to atmospheric pressure.

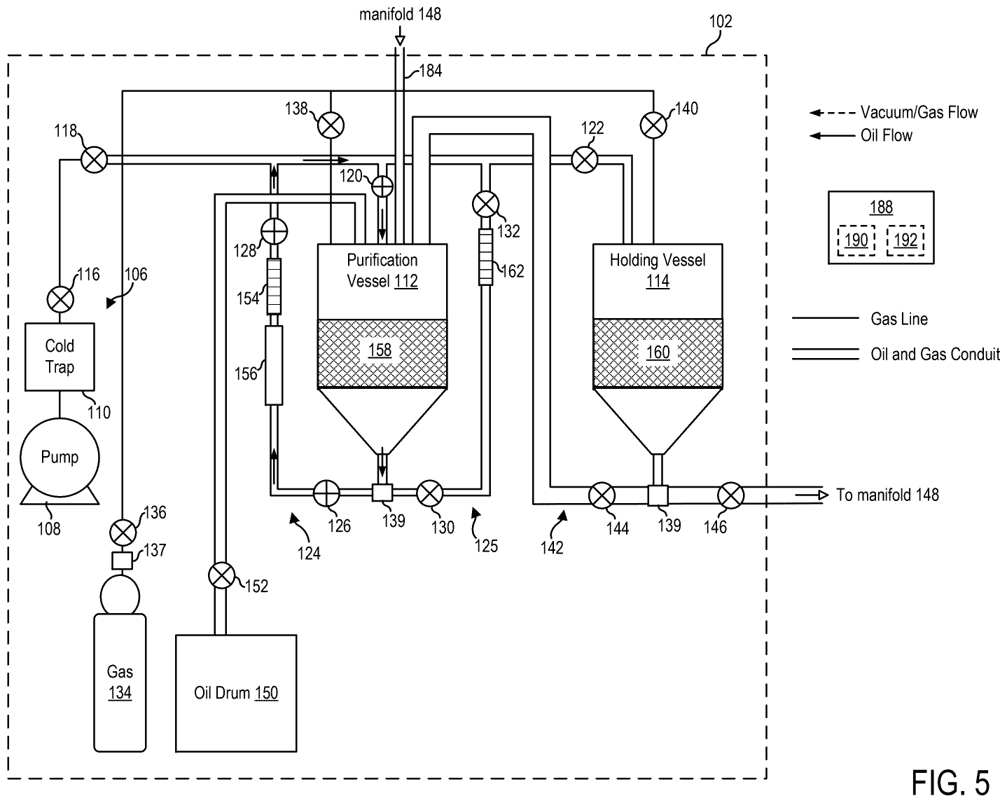

As shown in FIG. 5, the oil may be purified by closing the ninth and tenth valves 136, 138 and opening the third valve 120, the fifth valve 126, and the sixth valve 128. In at least one embodiment, the recirculation pump 156 may be activated to promote cycling of the oil through the recirculation circuit 124. In at least one embodiment, the oil may be passed through the first filter 154 according to a predetermined number of cycles or the oil may be circulated through the recirculation circuit 124 over a predetermined period of time. In at least another embodiment, the oil may be passed through the first filter 154 and cycled through the recirculation circuit 124 until a desired amount of purification of the oil is achieved. For example, the oil may be recirculated through the recirculation circuit 124 until a detected particulate concentration of the oil, as measured by a particulate sensor, decreases below a threshold level. Accordingly, in an example embodiment, a fluid (e.g., the oil) may be purified at least by cycling the fluid through one or more filters (e.g., the first filter 154) that are fluidically coupled to the purification vessel 112.

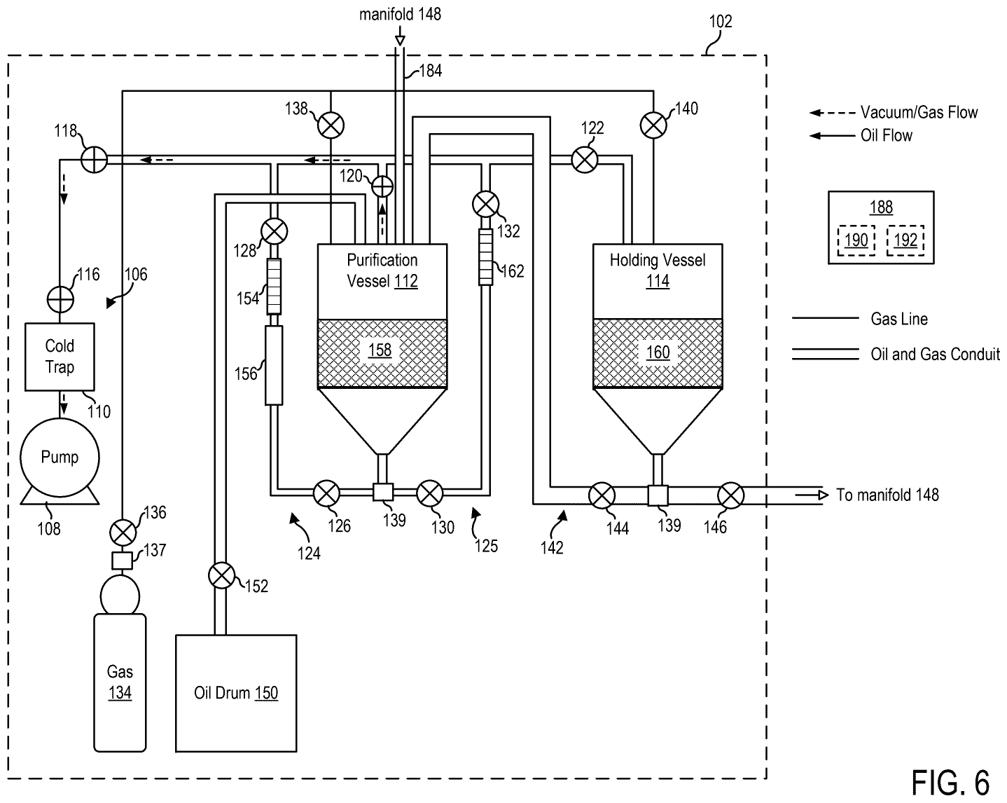

When cycling of the oil is complete, the oil may be further purified by placing the purification vessel 112 under vacuum and heating the purification vessel 112 to temperatures ranging from 40° C. to 100° C., depending on the type of oil, to drive off water. As shown in FIG. 6, this may include closing the fifth valve 126, and the sixth valve 128, maintaining the third valve 120 open, further opening the first and second valves 116, 118 to communicate vacuum generated by the first pump assembly 106 to the purification vessel 112. In some instances, an ambient oil collection trap may be placed in between valves 118 and 116 if necessary to inhibit pumping of the oil from into the first cold trap 110 and the first vacuum pump 108. In addition, activating the first heater 158 may increase the internal temperature of the purification vessel and promote evaporation of any water present in the oil. Water vapor extracted from the oil may flow into and condense within the first cold trap 110 and be trapped therein. Alternatively, in instances where a ballast is instead used, the gases, including water vapor, may be outgassed from the ballast. The purification vessel 112 may be placed under vacuum and heating for a predetermined period of time selected to decrease a water content of the oil to a threshold content. In at least one embodiment, the threshold content may be 30 ppm by weight or less. In at least one other embodiment, the threshold content may be 400 ppm by weight or less. Accordingly, in an example embodiment, a fluid (e.g., the oil) may be purified at least by heating the purification vessel 112 while the purification vessel 112 is fluidically coupled to a vacuum generated by a pump assembly (e.g., the first pump assembly 106).

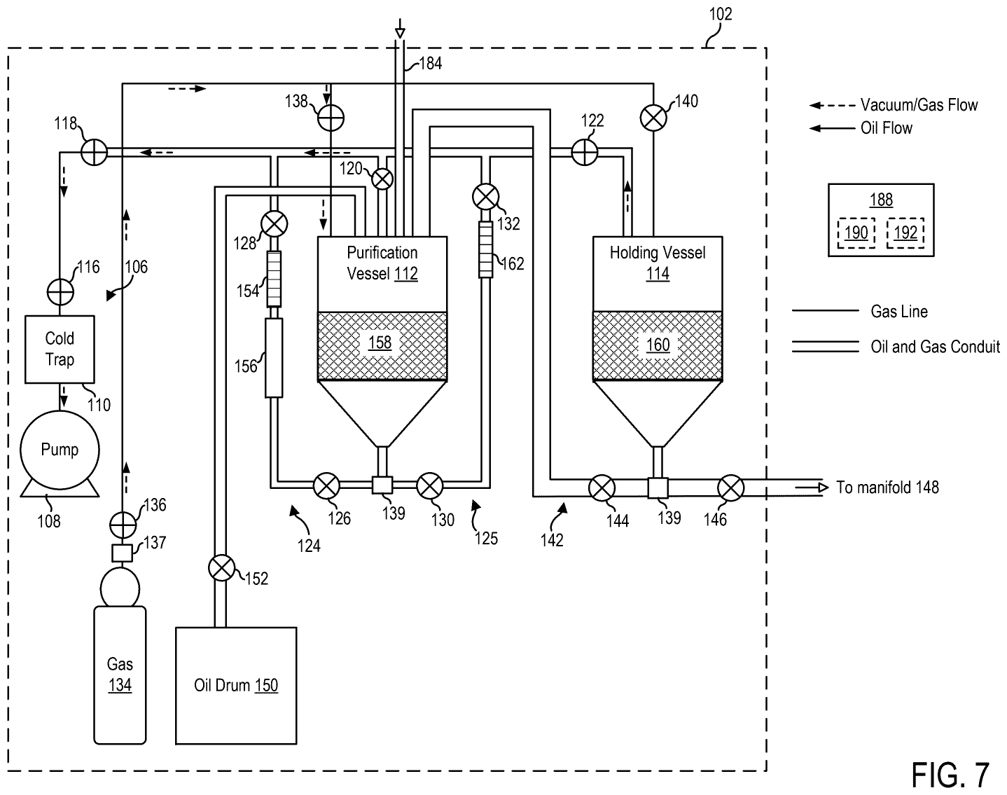

As illustrated in FIG. 7, after the oil in the purification vessel 112 is sufficiently dried (e.g., to a water content at or below the threshold percent or after a predetermined period of time lapses), the first heater 158 may be deactivated and the third valve 120 may be closed. Two operations may be performed concurrently: evacuation of the holding vessel 114 and repressurizing of the purification vessel 112. In at least one embodiment, evacuation of the holding vessel 114 may include maintaining the first and second valves 116, 118 open and further opening the fourth valve 122. Air may be evacuated from the holding vessel by operation of the first pump assembly 106. In at least one embodiment, the second heater 160 may be optionally activated and subsequently deactivated to promote drying of the holding vessel 114. In at least one embodiment, repressurizing of the purification vessel 112 may include opening the ninth valve 136 and the tenth valve 138 to deliver gas from the first gas supply 134 to the purification vessel 112 to return an internal pressure of the purification vessel 112 to at least atmospheric pressure. In at least one embodiment, the purification vessel 112 may be pressurized to above atmospheric pressure, such as up to 2 atm.

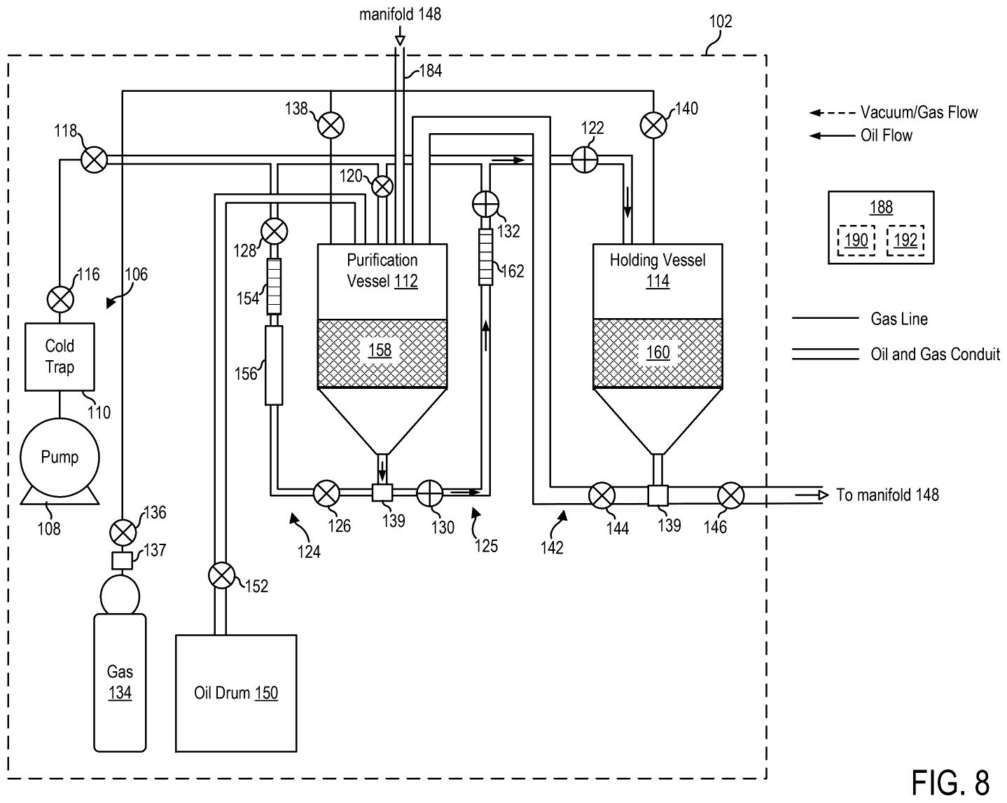

The evacuation of the holding vessel 114 and repressurizing of the purification vessel 112 may be maintained for respective predetermined periods of time, after which, as shown in FIG. 8, the first valve 116, the second valve 118, the ninth valve 136, and the tenth valve 138 may be closed. The fourth valve 122 may be maintained opened and the seventh valve 130, the eighth valve 132 may be further opened to fluidically couple the internal volume of the purification vessel 112 to an internal volume of the holding vessel 114. A pressure differential between the purification vessel 112 and the holding vessel 114 (e.g., higher at the purification vessel 112 and lower at the holding vessel 114) may drive flow of the oil from the purification vessel 112 into the holding vessel 114.

In at least one embodiment, the inner volume of the holding vessel 114 may be at least equal to or greater than the inner volume of the purification vessel 112 and all (or substantially all) of the oil stored in the purification vessel 112 may be transferred to the holding vessel 114. In at least another embodiment, the inner volume of the holding vessel 114 may be less than the inner volume of the purification vessel 112, or an amount of the oil stored in the purification vessel 112 is otherwise greater than the internal volume of the holding vessel 114, and only a portion of the oil stored in the purification vessel 112 may be transferred to the holding vessel 114. As the oil flows from the purification vessel 112 to the holding vessel 114, the oil may pass through the second filter 162 which may remove any remaining particles from the oil. When transfer of the oil is complete, the seventh valve 130, the eighth valve 132, and the fourth valve 122 may be closed. The oil may be stored in the holding vessel until impregnation of the capacitors 166 is initiated.

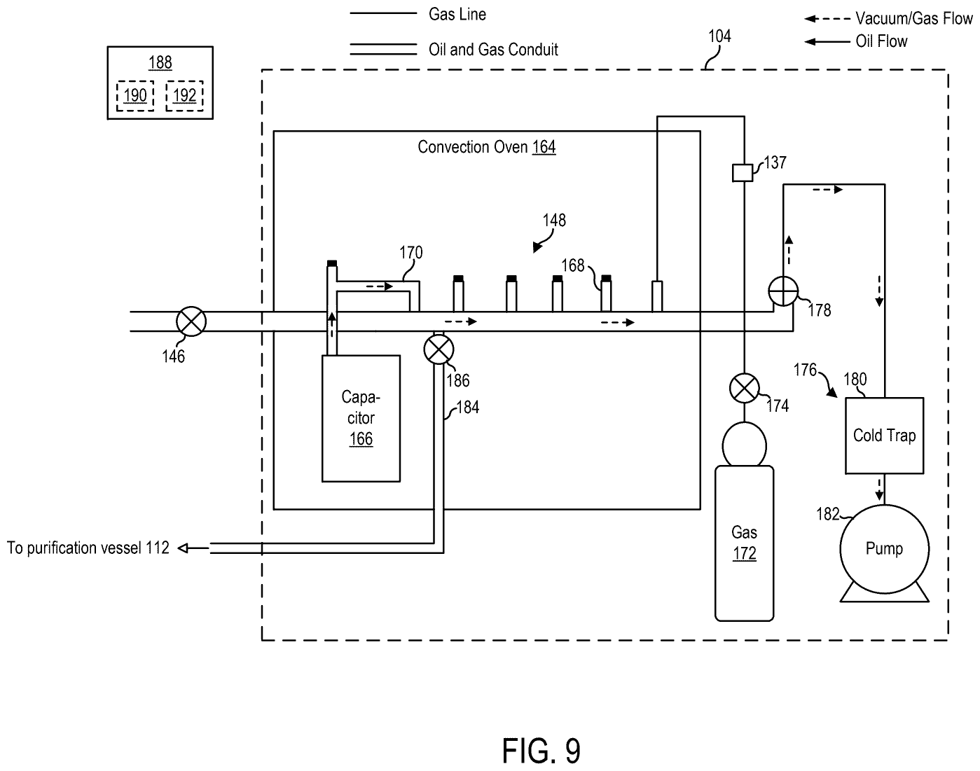

Charging of the capacitors 166 with the purified oil is now described with respect to FIGS. 9-15. As shown in FIG. 9, prior to filling the capacitors 166 with the oil, the capacitors 166 may first be prepared for charging by evacuating an internal volume of the capacitors 166. In at least one embodiment, evacuating the capacitors 166 may include activating the second pump assembly 176, e.g., by energizing the second vacuum pump 182, activating the convection oven 164 and opening the sixteenth valve 178 to communicate a vacuum generated by the second vacuum pump 182 to the capacitors 166 via the variable pressure manifold 148. In at least one embodiment, the convection oven 164 may be heated to a temperature within a range of 40° C. to 113° C. and an internal pressure of the capacitors 166 may be reduced to 100 mTorr or less. Other temperatures and levels of vacuum are possible, however, given that the combination of convective heating and vacuum are sufficient to evaporate water from the internal volumes of the capacitors 166 over a duration that may be 24 hours or less, or up to 72 hours. Drying of the capacitors 166 may be complete when a humidity within the capacitors falls to or below a threshold humidity level and vacuum levels fall below 100 mTorr. In at least one embodiment, the capacitors 166 may be ready for impregnation after being heated and evacuated for a period of up to 48 hours.

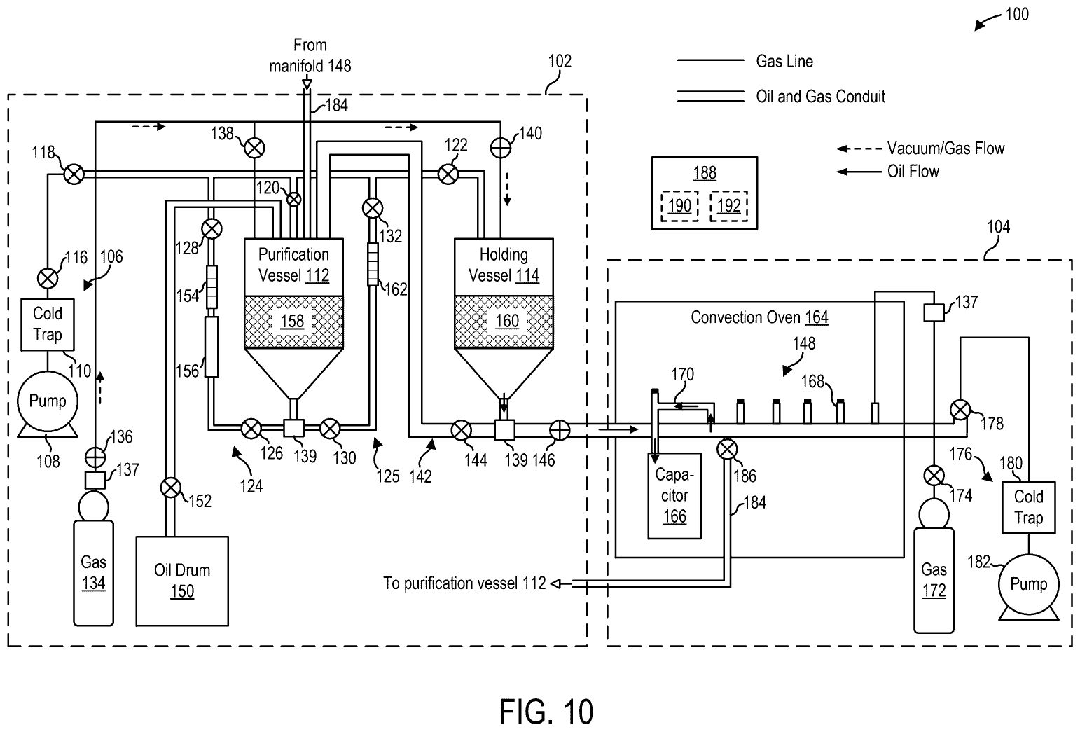

As shown in FIG. 10, the capacitors 166 may be charged with the purified oil after the capacitors 166 have been dried. In at least one embodiment, charging the capacitors may include maintaining the convection oven 164 on, closing the sixteenth valve 178, and opening the ninth valve 136, the eleventh valve 140, and the thirteenth valve 146. This allows a difference in pressure between the holding vessel 114 and the variable pressure manifold 148 (e.g., higher at the holding vessel 114 and lower at the variable pressure manifold 148), as indicated by dashed arrows with unfilled heads, to cause the purified oil to flow from the holding vessel 114 into the variable pressure manifold 148 and into the capacitors 166 (e.g., in parallel), as indicated by solid arrows. By opening the ninth and eleventh valves 136, 140, a backpressure generated at the first gas supply 134 may promote the flow of purified oil out of the holding vessel 114. In at least one embodiment, the backpressure may be a pressure of up to 2 atm. Accordingly, in an example embodiment, the variable pressure manifold 148 may charge the capacitors 166 with a purified fluid (e.g., the purified oil) when an internal pressure differential is generated between the holding vessel 114 and the variable pressure manifold 148. In an additional or alternative embodiment, the internal pressure differential may be generated by reducing a pressure in the variable pressure manifold 148 to below atmospheric pressure. For example, the purified fluid may be transferred from the holding vessel 114 to the capacitors 166 by conveying a vacuum, through the variable pressure manifold 148, to an internal volume of the capacitors 166 to generate an internal pressure differential between the holding vessel 114 and the capacitors 166, wherein the purified fluid may flow into the capacitors 166 based, at least in part, on the internal pressure differential generated between the holding vessel 114 and the capacitors 166.

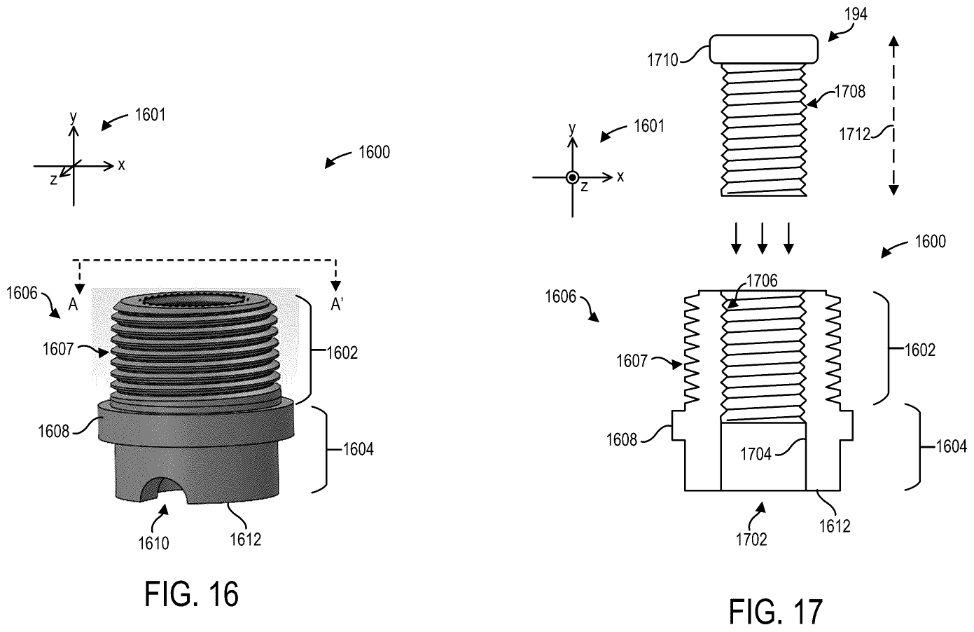

In at least one embodiment, the purified oil may flow from an outlet of the holding vessel 114, and into the variable pressure manifold 148. As the variable pressure manifold 148 is filled with the oil, the oil may also flow from the variable pressure manifold 148 into the adaptors 170 that couple each of the capacitors 166 to the variable pressure manifold 148. Each adaptor 170 may be connected to a fitting installed in a cover of one of the capacitors 166. In at least one embodiment, as described further below with reference to FIGS. 16-17, the fitting may be double-threaded with threading disposed on both an outer surface and an inner surface of the fitting such that the adaptor 170 may be mated with threading along the outer surface of the fitting. For example, one end of the adaptor 170, e.g., an end included in the portion of the adaptor 170 extending vertically above the respective capacitor 166, may circumferentially surround the fitting and a sealed interface may be formed between the adaptor 170 and the fitting by tightening the adaptor 170 along the outer threading of the fitting.

The capacitor 166 may be charged with the oil until the oil fills the inner volumes of the capacitor 166 and overflows into the adaptor 170. In some instances, the pressure differential between the holding vessel 114 and the variable pressure manifold 148 may not be sufficient to fill all of the capacitors 166 coupled to the variable pressure manifold 148 before the pressure differential dissipates. In such events, the thirteenth valve 146 may be closed, then the generation of a vacuum at the variable pressure manifold 148 may be repeated (as shown in FIG. 9), and filling of the capacitors 166 according to a pressure differential (as shown in FIG. 10) may also be repeated. In at least one embodiment, the process may cycle between the statuses shown in FIGS. 9 and 10 until all of the capacitors 166 and the respective adaptors 170 are filled with the oil.

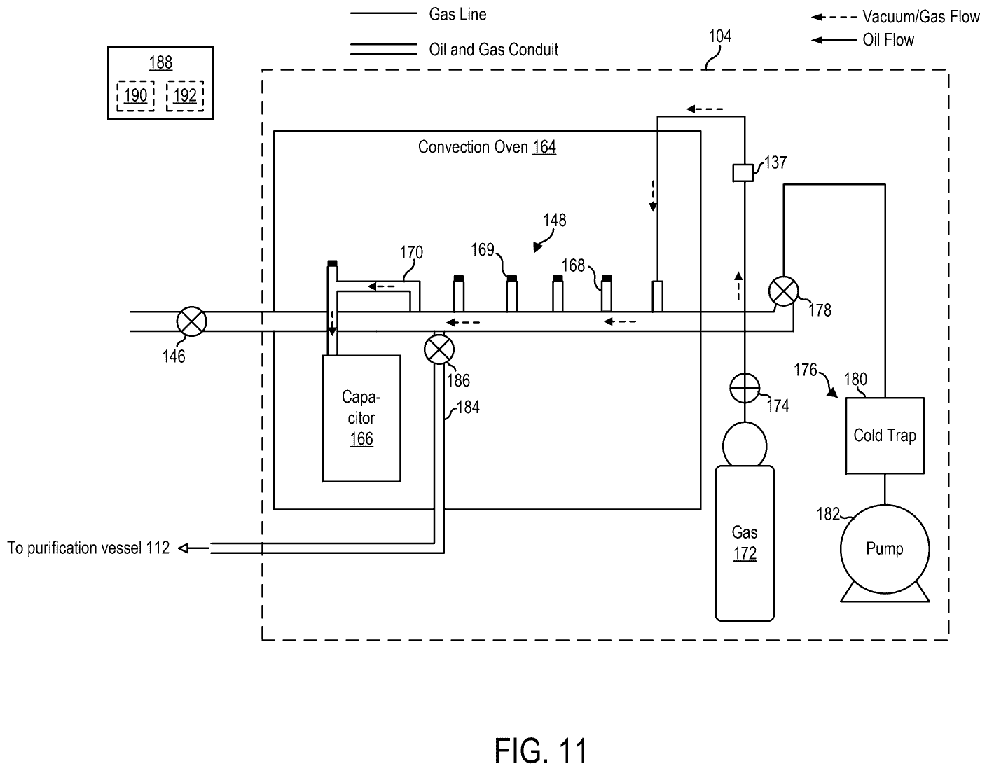

As shown in FIG. 11, when the capacitors 166 are filled with a desired amount of the purified oil (e.g., filled to overflowing such that a head layer of the oil is formed over the fittings of the capacitors 166), the capacitors 166 may undergo a soaking period to allow the oil to impregnate and/or fill void spaces within the capacitors 166. In at least one embodiment, this may include maintaining the convection oven 164 on, closing the ninth valve 136, the eleventh valve 140, and the thirteenth valve 146, and opening the fifteenth valve 174. A pressure in the variable pressure manifold 148 and within the capacitors 166 may increase upon opening the fifteenth valve 174, as indicated by dashed arrows with filled heads. In at least one embodiment, the pressure in the variable pressure manifold 148 and the capacitors 166 may increase from 2 atm up to 6.8 atm, or 29 psi up to 100 psi. In yet another embodiment, the pressure communicated to the variable pressure manifold 148 and the capacitors 166 from the second gas supply 172 may be in a range of 2 atm to 6.8 atm, or 29 psi to 100 psi.

By applying high pressures (e.g., higher than pressure generated at the first gas supply 134) to the variable pressure manifold 148 and the internal volumes of the capacitors 166, impregnation and penetration of the purified oil into internal voids of the capacitors 166 may be accelerated. In at least one embodiment, the pressure and convective heating may be applied continuously over the soaking period, which may be at least 48 hours in duration. In other embodiments, the pressure and convective heating may be applied intermittently to maintain the pressure and temperature at target levels, such as when the pressure is detected to drop below a threshold pressure and/or the temperature in the convection oven 164 is detected to fall below a preset temperature.

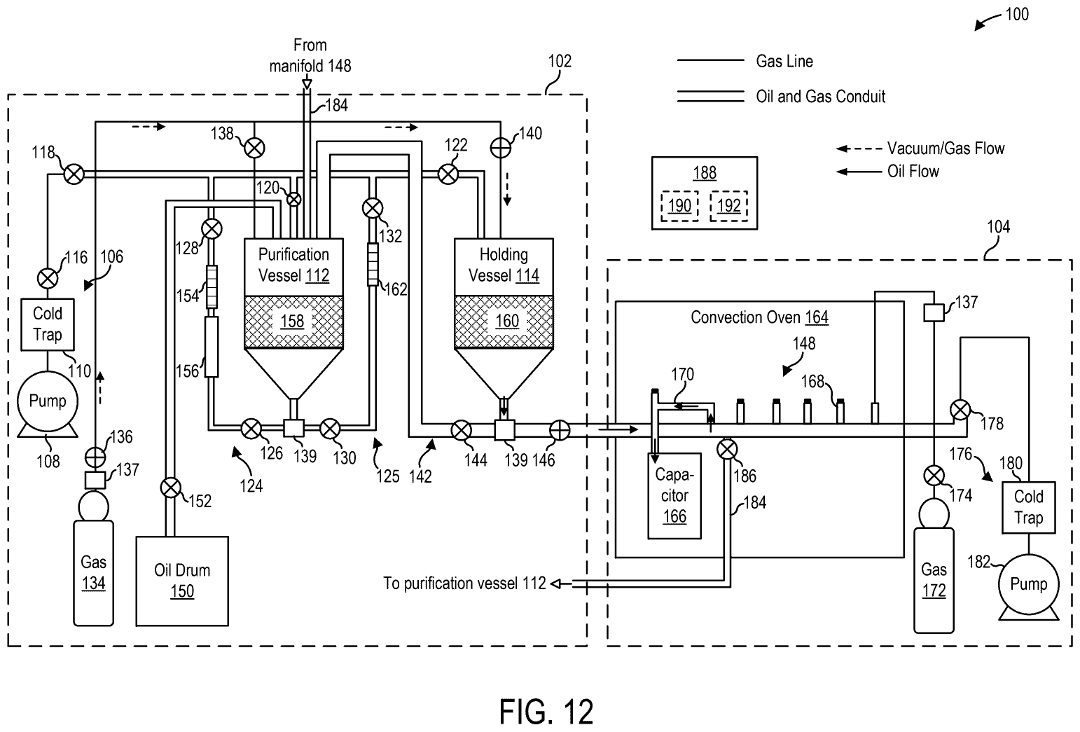

When the soaking period is complete, the fifteenth valve 174 may be closed, the convection oven 164 may be turned off (e.g., heating may be deactivated), and the capacitors 166 allowed to cool, as depicted in FIG. 12. In at least one embodiment, the capacitors 166 may be cooled convectively within the convection oven 164, such as by promoting circulation of air external to the convection oven 164 (e.g., air that is cooler than air within the convection oven 164) through the convection oven 164. Furthermore, the ninth valve 136, the eleventh valve 140, and the thirteenth valve 146 may be opened to supply the purified oil to the capacitors 166 as the oil in the capacitors 166 cools and contracts, causing the oil to decrease in volume. By maintaining a backpressure (e.g., a positive pressure) to the holding vessel 114 and opening the thirteenth valve 146, the capacitors 166 may be flooded with the purified oil flowing thereto as the oil within the capacitors 166 cools and contracts, thereby maintaining the capacitors 166 filled with the oil and mitigating formation of gas bubbles forming within the capacitors 166.

In at least one embodiment, the capacitors 166 may be cooled to room temperature via convective cooling. In at least one embodiment, cooling of the capacitors 166 to a target temperature (e.g., room temperature) may occur over a period of 3 hours. In other embodiments, the cooling may be complete over a duration ranging from 2 hours to 8 hours. The cooling of the capacitors 166 may therefore be expedited relative to conventional cooling of capacitors within a vacuum chamber enclosing the capacitors.

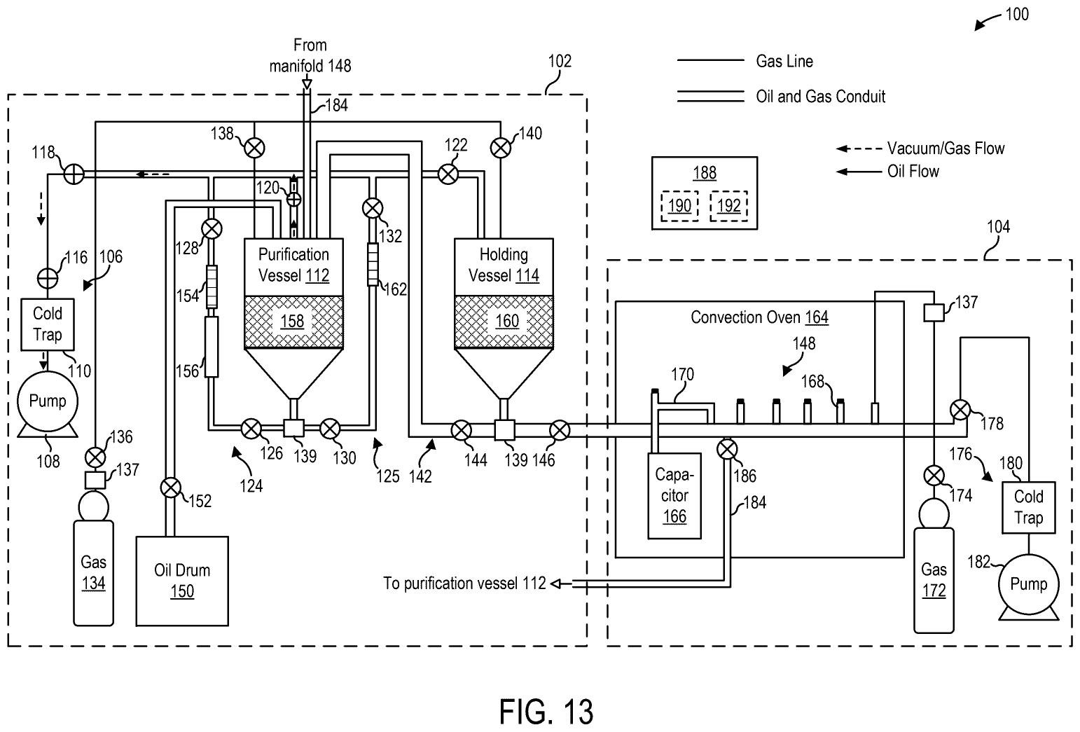

As shown in FIG. 13, when the capacitors 166 are sufficiently cooled, the ninth valve 136, the eleventh valve 140, and the thirteenth valve 146 may be closed, and the first valve 116, the second valve 118, and the third valve 120 may be opened. Opening the first and second valves 116, 118 may expose the purification vessel 112 to vacuum, as indicated by dashed arrows with unfilled heads, which may decrease the internal pressure of the purification vessel 112. In at least one embodiment, the internal pressure of the purification vessel 112 may be reduced to 100 mTorr.

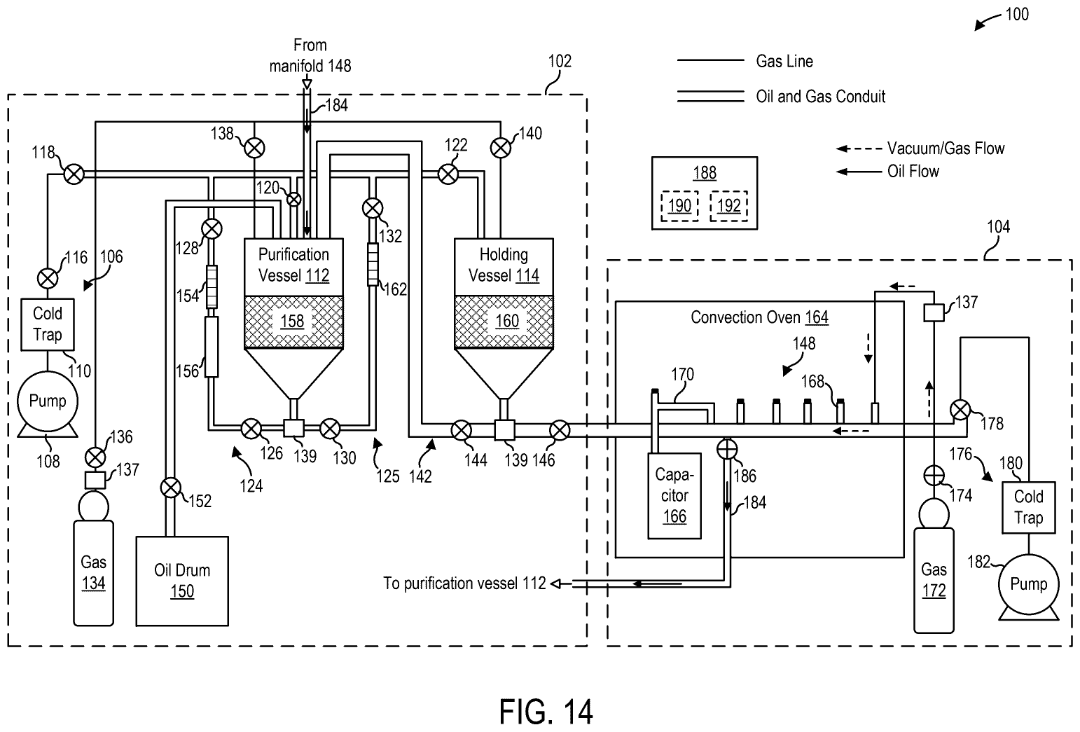

As depicted in FIG. 14, the first valve 116, the second valve 118, and the third valve 120 may be closed after evacuation of the purification vessel 112, and the fifteenth and seventeenth valves 174, 186, may be opened. An increase in pressure in the variable pressure manifold 148 may drive flow of the oil from the variable pressure manifold 148 to the purification vessel 112 through the drain 184. In at least one embodiment, the flow may be driven by a pressure differential between the variable pressure manifold and the purification vessel 112 (e.g., higher at the variable pressure manifold and lower at the purification vessel 112). By opening the fifteenth valve 174, the high pressure generated at the second gas supply 172 may maintain the pressure in the variable pressure manifold 148 higher than the pressure in the purification vessel 112 even as the purification vessel 112 receives the excess oil from the variable pressure manifold 148 and increases in pressure. In at least one embodiment, draining the oil from the variable pressure manifold 148 to the purification vessel 112 may allow oil in the impregnation portion 104 of the impregnation system 100 to be reclaimed and used for future charging events. In at least one embodiment, even when draining of the variable pressure manifold 148 is complete, the oil may remain in the adaptors 170 to maintain a head layer of the oil over openings (e.g., the fittings) of the capacitors 166, e.g., when the capacitors 166 are decoupled from the variable pressure manifold 148 and/or while the capacitors 166 are cooled after being impregnated with the oil.

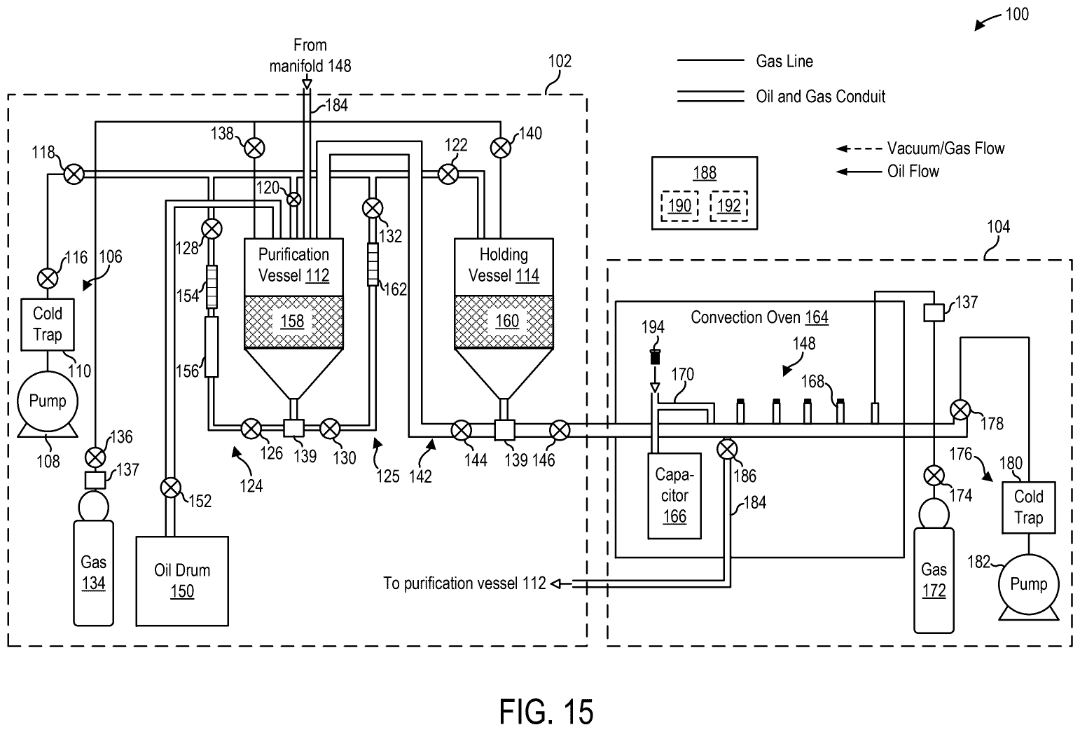

As depicted in FIG. 15, when the variable pressure manifold 148 is drained of the oil, with the oil remaining in the adaptors 170, the fifteenth and seventeenth valves 174, 186 may be closed. The capacitors 166 may be sealed to allow the capacitors 166 to be decoupled from the variable pressure manifold 148 and removed from the convection oven 164. In at least one embodiment, the capacitors 166 may be sealed using a threaded cap 194 shaped to mate with the fittings of the capacitors 166. For instance, the threaded cap 194 may include threading extending around a circumference of its outer surface to match the threading along the inner surface of the fitting. The threaded cap 194 may be inserted through the first section of the adaptor 170 that extends vertically above the fitting, when a plug 169 of the adaptor 170 is removed. In at least one embodiment, the threaded cap 194 may be at least partially submerged (e.g., fully submerged) in the head layer of the oil and then coupled to the fitting of the capacitor 166 by engaging the threads of the threaded cap 194 with the inner threading of the fitting. The capacitors 166 may thereby be sealed before the adaptors 170 are detached therefrom, which may maintain the head layer of the oil over the fitting while the threaded cap 194 is coupled to the fitting and circumvent introduction of air into the capacitors 166 while the capacitors 166 are being sealed.

In at least one embodiment, the adaptors 170 may include conduits (not shown) that can be fluidically coupled to the purification vessel 112 to allow oil remaining in the adaptors 170 after the capacitors 166 are sealed to be drained from the adaptors 170 into the purification vessel 112. In at least one example, an additional variable pressure manifold (not shown) or drains may be coupled to the adaptors 170 to collect the oil forming the head layers in the adaptors 170 over the fittings of the capacitors 166 to be returned to the purification vessel 112 for reuse.

An embodiment of a double-threaded fitting 1600 is depicted in FIG. 16 from a profile view and in FIG. 17 from a cross-sectional view. A set of Cartesian coordinate axes 1601 is shown in FIGS. 16 and 17 for contextualizing positions of the double-threaded fitting 1600 and for comparing between the various views of FIGS. 16 and 17. Specifically, x-, y-, and z-axes are provided which are mutually perpendicular to one another, where the x- and y-axes define a plane of the schematic cross-sectional diagram shown in FIG. 17 and the z-axis is perpendicular thereto. In some embodiments, a direction of gravity may be parallel to and coincident with any direction in the plane of the schematic cross-sectional diagram of FIG. 17. For example, the direction of gravity may be parallel and coincident with a negative direction of the y-axis. In additional or alternative embodiments, the direction of gravity may be within a plane defined by the y- and z-axes (e.g., parallel and coincident with a negative direction of the y-axis). In at least one embodiment, the y-axis may be parallel with a longitudinal axis of the double-threaded fitting 1600.

In at least one embodiment, at least a portion of the double-threaded fitting 1600 may be cylindrical in geometry, e.g., having a circular cross-sectional shape along the x-z plane. For example, the double-threaded fitting 1600 may include two portions that are stacked along the y-axis: a first portion 1602 and a second portion 1604. The first portion 1602 may be cylindrical, and may have a circular cross-sectional geometry when viewed along the x-z plane. The second portion 1604, however, may, in at least one embodiment, also be cylindrical and may also have a circular outer cross-sectional geometry when viewed along the x-z plane. In other embodiments, however, the second portion 1604 may instead have a different outer cross-sectional geometry, such as hexagonal, square, octagonal, etc.

In at least one embodiment, at least a portion of the outer surface 1606 of the double-threaded fitting 1600 at the first portion 1602 may include threading 1607. For example, at least a portion of the outer surface 1606 along the y-axis may be threaded. In at least one embodiment, the threading 1607 may be National Pipe Taper (NPT) threading, although other types of fitting interface may be used that are capable of providing sealed interfaces against seepage of fluids. By using NPT threading, the double-threaded fitting 1600 may provide sealed interfaces against both high pressures and vacuums. In at least one embodiment, the threading 1607 of the outer surface 1606 along the first portion 1602 may be configured to engage with an adaptor, such as the adaptor 170 of FIGS. 1-15, used to couple a capacitor to a manifold, such as the variable pressure manifold 148 of FIGS. 1-15. For example, the threading 1607 may be mated to a threading of the adaptor 170.

In at least one embodiment, an outer surface 1606 of the double-threaded fitting 1600 at the second portion 1604 may not include the threading 1607 and may instead be smooth and linear with respect to the y-axis. In some instances, the second portion 1604 may be a base of the double-threaded fitting 1600 that may be inserted into a receiving opening or port in a cover of a device, such as a capacitor, and fixedly coupled to the cover of the device. In at least one embodiment, the second portion 1604 may be embedded in the cover of the device. In at least one embodiment, the double-threaded fitting 1600 may have a flange 1608 which may allow the double-threaded fitting to be welded to the cover of the device, although other techniques for securing the double-threaded fitting 1600 to the device are possible. In at least one embodiment, the double-threaded fitting 1600 may be permanently coupled, e.g., not readily removed, to the cover of the device at the second portion 1604. In other embodiments, however, the outer surface 1606 of the double-threaded fitting 1600 at the second portion 1604 may include the threading 1607 to mate with threading at an opening or port of a device at which the double-threaded fitting is to be implemented, or the outer surface 1606 may be textured.

The second portion 1604 may further include a notch 1610 at an end of the double-threaded fitting 1600. In at least one embodiment, as shown in FIG. 16, the notch 1610 may have a semi-circular geometry along an edge 1612 of the double-threaded fitting 1600, although other shapes, sizes, and quantities of the notch 1610 are possible. By implementing the notch 1610 along the edge of the double-threaded fitting 1600, clogging of the double-threaded fitting may be mitigated when the double-threaded fitting 1600 is coupled to an adaptor (e.g., the adaptor 170 of FIGS. 1 and 9-15) and the edge 1612 of the double-threaded fitting is pressed against internal insulation of a capacitor.

The cross-sectional view of the double-threaded fitting 1600 illustrated in FIG. 17 may be obtained by slicing the double-threaded fitting 1600 along line A-A′ depicted in FIG. 16. As shown in FIG. 17, the double-threaded fitting 1600 may include an inner bore 1702, which may be an opening that extends entirely through the double-threaded fitting 1600 along the y-axis. In at least one embodiment, a fluid, such as an oil, may be flowed through the inner bore 1702. The inner bore 1702 may have a circular cross-sectional geometry (e.g., when viewed along the x-z plane) at least through the first portion 1602. A surface of the inner bore 1702 may form an inner surface 1704 of the double-threaded fitting 1600. Along at least the first portion 1602 of the double-threaded fitting 1600, the inner surface 1704 may be threaded. In at least one embodiment, threading 1706 at the inner surface 1704 may be configured to engage (e.g., mate) with threading 1708 of the threaded cap 194 used to seal a capacitor as illustrated in FIG. 15. In at least one embodiment, when the threading 1708 of the threaded cap 194 is engaged with the threading 1706 of the inner surface 1704 of the double-threaded fitting 1600, the surfaces of the respective threading may form a sealed interface that blocks flow of fluids through the inner bore 1702. Accordingly, in an example embodiment, the double-threaded fitting 1600 may include a first set of threading (e.g., the threading 1607) disposed at or along the outer surface 1606 and a second set of threading (e.g., the threading 1706) disposed at or along the inner surface 1704. In some embodiments, the threaded cap 194 may be coupled to the threading 1706 while the threading 1607 is coupled to the adaptor 170. For example, the adaptor 170 may engage with the threading 1607 when a capacitor is coupled to a manifold and the threaded cap 194 may engage with the threading 1706 when the capacitor is sealed.

In at least one embodiment, the inner surface 1704 along the second portion 1604 of the double-threaded fitting 1600 may not include threading. In some instances, however, e.g., as shown in FIG. 17, at least a portion of the inner surface 1704 along the second portion 1604 may be threaded. For example, extension of the threading 1706 along the inner surface 1704 of the double-threaded fitting 1600 (e.g., along the y-axis) may vary depending on a length 1712 of the threaded cap 194 (e.g., as defined along the y-axis). In at least one embodiment, the threading 1706 may extend entirely along the inner surface 1704 (e.g., from one end of the double-threaded fitting 1600 to the other along the y-axis).

In at least one embodiment, the inner bore 1702 may maintain a circular cross-sectional geometry (when viewed along the x-z plane) through the second portion 1604 of the double-threaded fitting 1600, whether the inner surface 1704 is threaded or not threaded. In other embodiments, the cross-sectional geometry of the inner bore 1702 that does not include threading may not be circular or may match the outer cross-sectional geometry of the double-threaded fitting 1600 at the second portion 1604.

In at least one embodiment, the threaded cap 194 may include a head 1710 that may protrude from the double-threaded fitting 1600 when the threaded cap 194 is inserted into and tightened against the double-threaded fitting 1600. The protruding head 1710 may provide a portion of the double-threaded fitting 1600 to which a fastening tool may be coupled to both insert and remove the threaded cap 194. As an example, the protruding head 1710 may have an outer geometry configured to be engaged with a wrench, a screwdriver, or some other type of fastening tool. In at least one embodiment, the fastening tool may be used to couple the threaded cap 194 to the inner bore 1702 of the double-threaded fitting 1600 while the outer surface 1606 of the double-threaded fitting 1600 is coupled to an adaptor (e.g., the adaptor 170 of FIGS. 1-15). For example, as described previously, the adaptor may store an amount of a fluid, such as an oil, to form a head layer of the fluid over the double-threaded fitting 1600. The head layer may be formed to maintain the double-threaded fitting 1600 at least partially submerged (e.g., fully submerged) in the fluid while the threaded cap 194 is coupled to the double-threaded fitting 1600.

In alternate embodiments, a different type of vacuum adaptor (e.g., fitting) may be used in place of the double-threaded fitting 1600. For example, instead of relying on inner and outer threading, a fitting used to couple a capacitor to a manifold may be configured to interface with a cap via a pressure or interference fit along an inner surface of the fitting, and include threading along its outer surface to couple to a component extending between a port of the manifold and the capacitor (e.g., the adaptor 170). Alternatively, the fitting may mate with the component using a pressure or interference fit along its outer surface and interface with the cap via threading along its inner surface, or may rely on pressure or interference fits along both its inner and outer surfaces. In yet other embodiments, the fitting may be coupled concurrently to the component and the cap in various ways while providing sealed interfaces with each of the adaptor and the cap while being fixedly coupled to the capacitor. For instance, the fitting may be configured as a vacuum hose adaptor, a quick click adaptor, a Luer adaptor, a locking adaptor, a plug adaptor, or any combination thereof, among others.

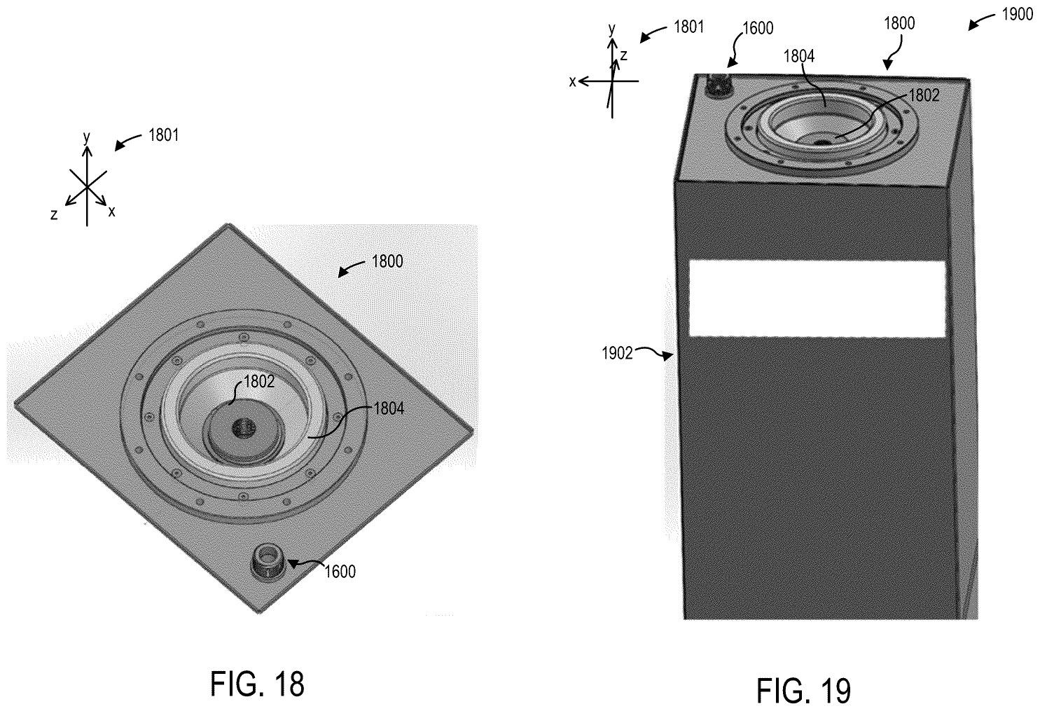

Referring now to FIGS. 18 and 19, an embodiment is illustrated of a cover 1800 for a device 1900 (as shown in FIG. 19) in which the double-threaded fitting 1600 may be installed. In at least one embodiment, the device 1900 may be a capacitor 1900, similar to the capacitor 166 of FIGS. 1-15. A set of Cartesian coordinate axes 1801 is shown in FIGS. 18 and 19 for contextualizing positions of the cover 1800 and for comparing between the various views of FIGS. 18 and 19. Specifically, x-, y-, and z-axes are provided which are mutually perpendicular to one another. In at least one embodiment, a direction of gravity may be parallel and coincident with a negative direction of the y-axis. In additional or alternative embodiments, the direction of gravity may be within a plane defined by the y- and z-axes (e.g., parallel and coincident with a negative direction of the y-axis).

In at least one embodiment, the cover 1800 may be a panel with structures arranged concentrically in a central region of the cover 1800. For example, the central region of the cover 1800 may include a conductive core 1802 circumferentially surrounded by a bushing 1804. In at least one embodiment, the conductive core 1802 may be formed of an electrically conductive material, such as a metal or metal alloy, and the bushing 1804 may be formed of an electrically insulating material, such as porcelain or another ceramic, although other insulating materials may be used. The bushing 1804 may control a shape and a strength of an electric field generated at the conductive core 1802. In an example embodiment, the double-threaded fitting 1600 may be coupled to the cover 1800, e.g., in a peripheral region of the cover 1800, so as to protrude away from an interior volume of the capacitor 1900. As an example, the first portion 1602 of the double-threaded fitting 1600 may extend away from the cover 1800 and the second portion 1604 of the double-threaded fitting 1600 may be embedded in the cover 1800.

The cover 1800 may form a panel of the capacitor 1900, which, when coupled to a capacitor body 1902 at least partially enclosing the interior volume of the capacitor 1900, may form a sealed structure when assembled. In at least one embodiment, the capacitor 1900 may be a sealed structure filled with an oil, e.g., a dielectric, or other fluid and may be usable to energize a plasma confinement system. Accordingly, in an example embodiment, the interior volume of the capacitor 1900 may be impregnated with a purified fluid. Although depicted in FIG. 19 with a rectangular outer geometry, other shapes and relative dimensions of the capacitor 1900, as well as other orientations and positionings of the conductive core 1802, the bushing 1804, and the double-threaded fitting 1600 are possible without departing from the scope of the present disclosure.

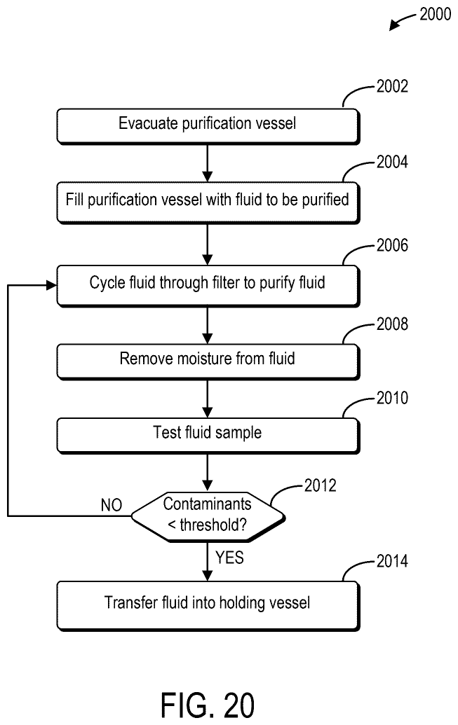

A block diagram of a method 2000 for purifying a fluid, such as an oil, to be used to charge a device, is shown in FIG. 20 in accordance with at least one embodiment. In at least one embodiment, the method 2000 may be implemented at an impregnation system such as the impregnation system 100 of FIGS. 1-15 and may be performed as depicted in FIGS. 1-8 (e.g., via opening and closing of various valves).

In some embodiments, the method 2000, or a portion thereof, may be implemented as executable instructions stored in non-transitory memory of a computing device, such as a controller, e.g., the controller 188 of FIGS. 1-15, communicably coupled to the impregnation system. Moreover, in certain embodiments, additional or alternative sequences of steps may be implemented as executable instructions on such a computing device, where individual steps discussed with reference to the method 2000 may be added, removed, substituted, modified, or interchanged.

At block 2002, the method 2000 may include evacuating a purification vessel by applying a vacuum to the purification vessel, as shown, for example, in FIG. 2. In at least one embodiment, the purification vessel may be evacuated until an internal pressure of the purification vessel reaches a threshold level of vacuum or a predetermined period of time elapses. In another embodiment, the purification vessel may be evacuated until a content of one or more molecules and/or atoms, such as atmosphere (e.g., N₂), water, H, H₂, O, O₂, or OH falls below a threshold level. When the purification vessel has been evacuated according to the threshold vacuum level or predetermined period of time, the purification vessel may be at least partially filled with the oil at block 2004, as shown, for example in FIG. 3. In at least one embodiment, the flow of the oil may be driven by a pressure differential between the purification vessel and a storage reservoir of the unpurified oil. When the purification vessel is filled to a desired level, the purification vessel may be repressurized to at least atmospheric pressure, as shown, for example, in FIG. 4.

At block 2006, the method 2000 may include purifying the oil by cycling the oil through a filter arranged in a recirculation circuit of the impregnation system, as shown, for example in FIG. 5. For example, the purification vessel may be repressurized to at least atmospheric pressure and a pump may be activated to circulate the oil through the recirculation circuit. In some embodiments, the oil may be cycled through the recirculation circuit over a predetermined number of cycle or over a predetermined duration of time. In at least one embodiment, the oil may be cycled until a concentration of particulate matter in the oil fall below a minimum threshold, after which, the pump may be deactivated.

At block 2008, the method 2000 may include removing moisture from the oil in the purification vessel, as shown, for example, in FIG. 6. In at least one embodiment, removing the water may include heating the purification tank and applying vacuum to the purification tank to vaporize any water in the oil and pull the water vapor into a ballast or cold trap of a pump assembly.

At block 2010, the method 2000 may include testing a sample of the oil. In at least one embodiment, the sample of the oil may be obtained from an oil sample chamber, such as the oil sample chambers 139 of the impregnation system 100 of FIGS. 1-15. In at least one embodiment, the oil may be analyzed for one or more parameters including particulate concentration, water content, and fluid resistivity and compared to thresholds for the parameters.

At block 2012, the method 2000 may include confirming if one or more of the parameters that the oil sample is tested for is below a corresponding threshold. In at least one embodiment, if at least one of the parameters is not measured to be below the corresponding threshold, the method 2000 may include returning to block 2006 to continue cycling the oil through the filter. If the testing of the oil sample confirms that all measured parameters are below their respective thresholds, the method 2000 may include terminating the heating of the purification vessel, and the purification chamber may be repressurized to at least atmospheric pressure, as shown, for example, in FIG. 7.

At block 2014, the method 2000 may include transferring the purified fluid from the purification vessel to a holding vessel, as shown, for example, in FIG. 8. Transferring the purified fluid may include, for example, evacuating the holding vessel by applying a vacuum to the holding vessel until a pressure in the holding vessel falls below a threshold pressure or a predetermined duration of time elapses, as shown, for example, in FIG. 7. In at least one embodiment, when the holding vessel is sufficiently evacuated, flow of the oil from the purification vessel to into the holding vessel may be driven by a pressure differential between the purification vessel and the holding vessel. The purified oil may be stored in the holding vessel without exposure to contaminants until the oil is to be used.

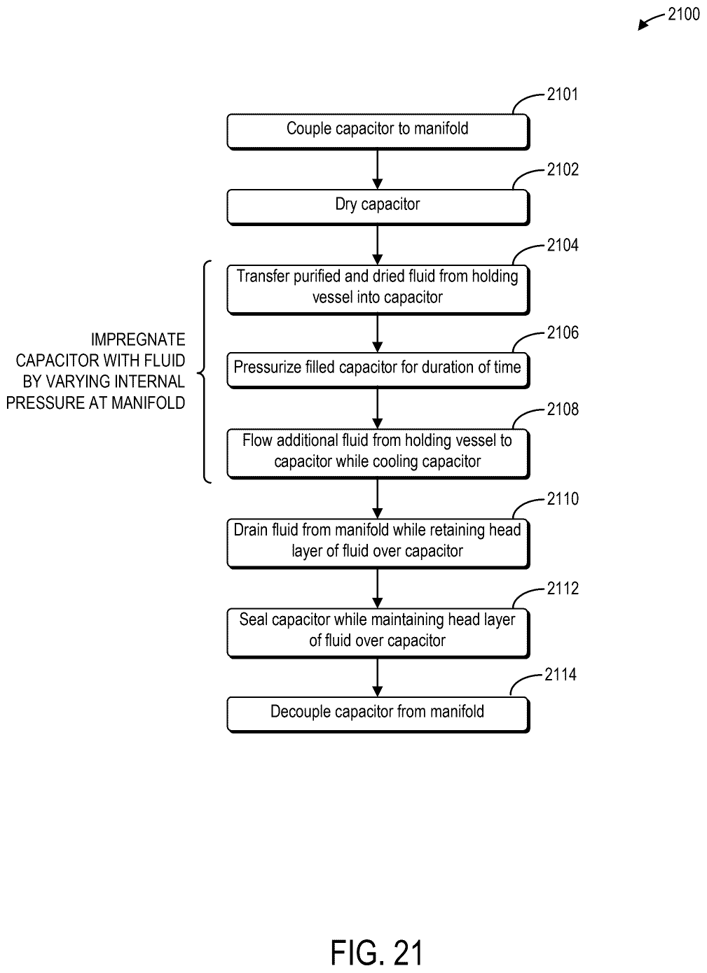

A block diagram of a method 2100 for impregnating a device, such as a capacitor or other receptacle, with a fluid, such as an oil, is shown in FIG. 21 in accordance with at least one embodiment. In at least one embodiment, the method 2100 may be implemented at an impregnation system such as the impregnation system 100 of FIGS. 1-15 and may be performed as depicted in FIGS. 9-15 (e.g., via opening and closing of various valves). The capacitor may be similarly configured to the capacitor 166 of FIG. 1 and the capacitor 1900 of FIG. 19 and may include a double-threaded fitting such as the double-threaded fitting 1600 of FIGS. 16-19 to fluidically couple the capacitor to a variable pressure manifold (e.g., a vacuum manifold). It will be noted that although impregnation of a single capacitor is described, any number of additional capacitors may be similarly impregnated with oil simultaneous with the capacitor.

In some embodiments, the method 2100, or a portion thereof, may be implemented as executable instructions stored in non-transitory memory of a computing device, such as a controller, e.g., the controller 188 of FIGS. 1-15, communicably coupled to the impregnation system. Moreover, in certain embodiments, additional or alternative sequences of steps may be implemented as executable instructions on such a computing device, where individual steps discussed with reference to the method 2100 may be added, removed, substituted, modified, or interchanged.

Furthermore, in at least one embodiment, the impregnation of the capacitor as described by the method 2100 may occur independent of the purification of the oil as described by the method 2000. In at least one embodiment, the method 2100 may be carried out after the method 2000 has been performed. In another embodiment, the method 2100 may be carried out at least partially in parallel with the method 2000. For example, the capacitor may be dried while the method 2000 is performed, or portions of the method 2000 may be performed in parallel with portions of the method 2100 after the capacitor has been charged with the oil (e.g., to purify oil to be supplied to further capacitors).

At block 2101, the method 2100 may include coupling the capacitor to the variable pressure manifold. In at least one embodiment, coupling the capacitor to the variable pressure manifold may include fluidically coupling the capacitor to the variable pressure manifold such that a range of pressures may be communicated to the capacitor via the variable pressure manifold.

At block 2102, the method 2100 may include drying the capacitor to prepare the capacitor for impregnation with the oil, as shown, for example, in FIG. 9. In at least one embodiment, drying the capacitor may include applying vacuum to the capacitor through the variable pressure manifold and activating a convection oven in which the variable pressure manifold and the capacitor is enclosed to heat the capacitor. Any moisture in the capacitor may thereby be vaporized and removed. In at least one embodiment, by utilizing convective heating to heat the capacitor while maintaining an inner volume of the convection oven at atmospheric pressure, the capacitor may be dried in 3 hours. Accordingly, in an example embodiment, the capacitor may be heated prior to being impregnated/charged with a purified fluid (e.g., the oil). In an additional or alternative embodiment, prior to being impregnated/charged with the purified fluid, the capacitor may be evacuated by exposing an internal volume of the capacitor to a pressure lower than atmospheric pressure conveyed through the variable pressure manifold while the capacitor is heated externally by convective heating.

At block 2104, the method 2100 may include transferring the purified and dried oil from the holding vessel into the capacitor via the variable pressure manifold while heating of the capacitor and the variable pressure manifold is maintained, as shown, for example, in FIG. 10. In at least one embodiment, transferring the oil into the capacitor may include applying a backpressure to the holding vessel and allowing a pressure differential between the holding vessel and the capacitor to cause the oil to flow out of the holding vessel into the variable pressure manifold, through an adaptor coupling the capacitor to the variable pressure manifold, and into the capacitor. If, when the pressure differential dissipates, the capacitor is not filled, vacuum may again be communicated to the capacitor to recreate the pressure differential between the holding vessel and the capacitor to cause more oil to flow into the capacitor. This may be repeated until the capacitor is filled. In at least one embodiment, when the capacitor is filled, the oil may also be present (e.g., stored) in the adaptor and in the variable pressure manifold.

At block 2106, the method 2100 may include pressurizing the capacitor while maintaining the capacitor heated, as shown, for example, in FIG. 11. In at least one embodiment, pressure may be communicated to the capacitor through the variable pressure manifold from a gas supply and may be a pressure of up to 100 psi. In at least another embodiment, the capacitor may be pressurized in a range from 14.7 psi up to 80 psi. Accordingly, in an example embodiment, the variable pressure manifold may be pressurized to a pressure of up to 80 psi while the capacitor is impregnated with a purified fluid (e.g., the oil). The capacitor may be maintained at the pressure and with heating for a threshold period of time, such as at least 48 hours. During the threshold period of time, the oil may seep further into the capacitor and fill voids therein. As such, the oil in the adaptor and in the variable pressure manifold may continue to flow into the capacitor as the capacitor is impregnated with the oil. In at least one embodiment, after threshold period of time elapses, the heating may be terminated and the variable pressure manifold may be fluidically decoupled from the gas supply. In at least one embodiment, the residual pressure in the variable pressure manifold and the capacitor may be maintained (e.g., not vented). In at least another embodiment, the pressure in the variable pressure manifold and the capacitor may be vented to decrease the pressure therein to atmospheric pressure. In an example embodiment, a pump assembly may be used to decrease the pressure within the variable pressure manifold.

At block 2108, the method 2100 may include cooling the capacitor while additional oil is added to the capacitor, as shown, for example, in FIG. 12. In at least one embodiment, the capacitor may be cooled, which may otherwise induce thermal contraction of the oil that may cause voids or bubbles to form, by allowing the convection oven to circulate air that is cooler than an internal volume of the convection oven through the internal volume of the convection oven. In at least one embodiment, the additional oil may be added to the capacitor by fluidically coupling the holding vessel to the capacitor through the variable pressure manifold, and applying a backpressure to the holding vessel to promote flow of the oil from the holding vessel to the capacitor. As the capacitor cools and the oil stored therein contracts, more oil may thereby be added to the capacitor to maintain the capacitor full of oil. In at least one embodiment, the capacitor may be cooled until an internal temperature of the capacitor reaches an ambient temperature.

Accordingly, in an example embodiment, the capacitor may be impregnated with a fluid (e.g., the purified and dried oil) by varying an internal pressure at the variable pressure manifold (e.g., at the blocks 2104, 2106, and 2108). As an example, and as described with reference to the block 2106, varying the internal pressure at the variable pressure manifold may include activating one or more valves to convey one of a higher pressure generated by a gas supply or a lower pressure generated by a pump assembly. As an additional or alternative example, and as described with reference to the block 2108, impregnating the capacitor with the fluid may include maintaining a positive pressure of the fluid flowing to the capacitor while the capacitor is cooled by convective cooling (e.g., after the capacitor has been charged or otherwise filled with the fluid and while the fluid thermally contracts and/or bubbles or voids are removed from the fluid).

At block 2110, the method 2100 may include draining the oil remaining in the variable pressure manifold into the purification vessel, as shown, for example, in FIG. 14. In at least one embodiment, draining the oil may include evacuating the purification vessel, as shown, for example, in FIG. 13, to reduce a pressure within the purification vessel and create a pressure differential between the variable pressure manifold and the purification vessel. In at least one embodiment, creating the pressure differential may further include applying a backpressure to the variable pressure manifold (e.g., from the gas supply). For example, the backpressure may be a pressure of 2 atm and may assist in driving the drainage of the oil from the variable pressure manifold into the purification vessel. In at least one embodiment, oil may remain in the adaptor even when the variable pressure manifold has been drained. In at least one embodiment, the oil may be drained until an amount of oil remaining in the variable pressure manifold is detected to fall below a threshold amount or until no more (or substantially no more) oil flows into the purification vessel.

At block 2112, the method 2100 may include sealing the capacitor while the head layer of the oil, formed of oil remaining in the adaptor, is maintained. In at least one embodiment, the head layer of the oil may be formed over a double-threaded fitting of the capacitor connected to the adaptor and enclosed by an end of the adaptor. The adaptor may be configured with, for example, a removable plug through which a threaded cap may be inserted to be coupled to the double-threaded fitting (e.g., as shown in FIG. 15). In at least one embodiment, the threaded cap may be coupled to the double-threaded fitting to form a sealed interface therebetween while the adaptor remains attached to the double-threaded fitting and at least a head layer of oil remains in the adapter and on top of the threaded cap. Accordingly, in an example embodiment, the capacitor may be sealed while remaining coupled to the variable pressure manifold. As an example, sealing the capacitor may include inserting the threaded cap through the adaptor coupling the capacitor to the variable pressure manifold and coupling the threaded cap to the double-threaded fitting. As an additional or alternative example, sealing the capacitor may include coupling the threaded cap to the double-threaded fitting while the double-threaded fitting is submerged in a fluid (e.g., the head layer of the oil).

At block 2114, the method 2100 may include decoupling the capacitor from the variable pressure manifold. In at least one embodiment, decoupling the capacitor may include draining the oil in the adaptor from the adaptor and into the purification vessel. For example, a variable pressure manifold or a drain may be coupled to the adaptor to fluidically couple the adaptor to the purification vessel. In at least one embodiment, a pressure differential may be generated between the purification vessel and the adaptor by applying a vacuum to the purification vessel to cause the oil to flow into the purification vessel. In addition, an optional backpressure may be applied to the adaptor through the variable pressure manifold to promote flow of the oil out of the adaptor. The adaptor may be fluidically decoupled from the purification vessel when the oil is drained out of the adaptor and the adaptor may be decoupled from the double-threaded fitting. The capacitor, being impregnated with oil and sealed, may be used to supply energy (power) to a system, such as the plasma confinement system described further below.

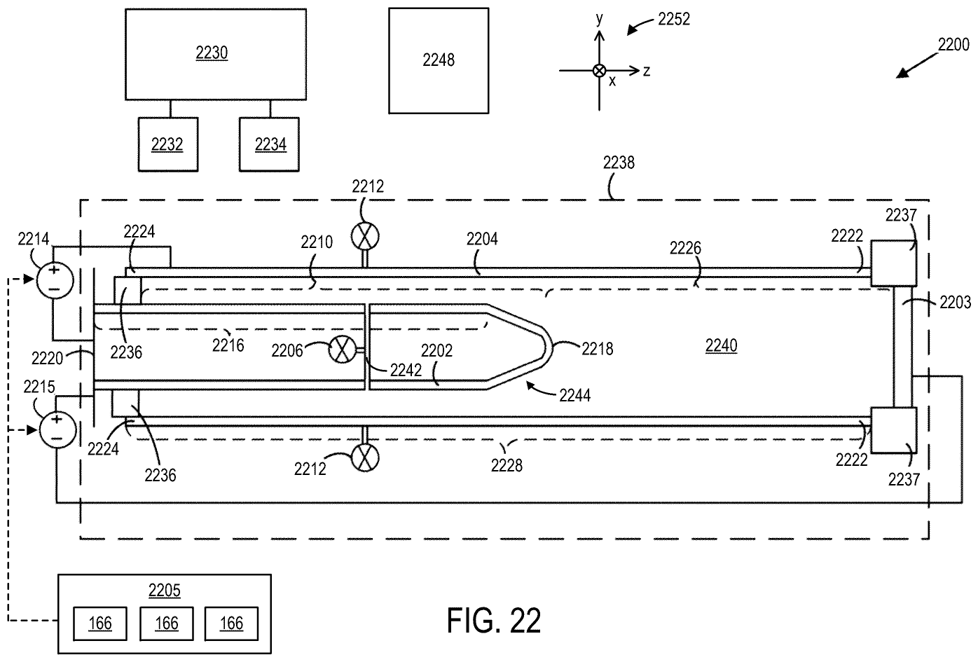

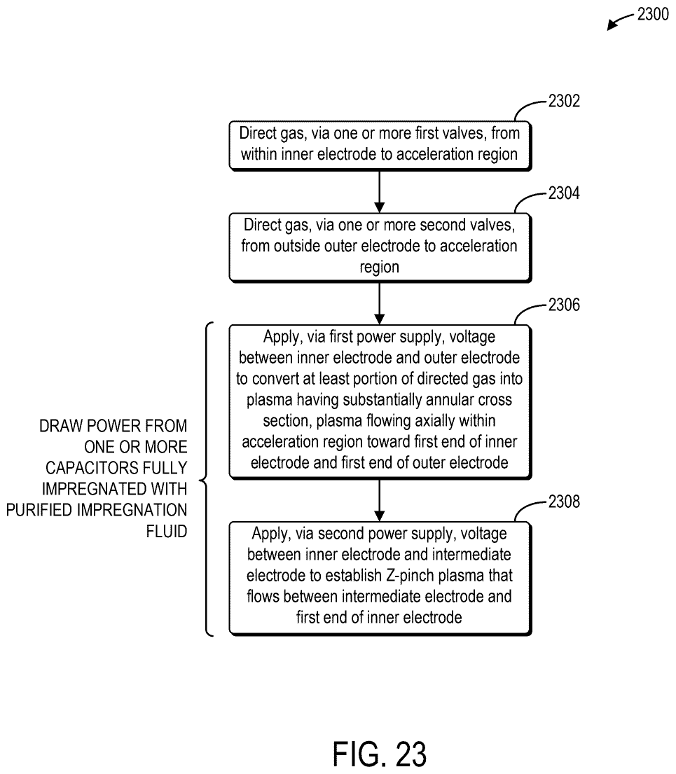

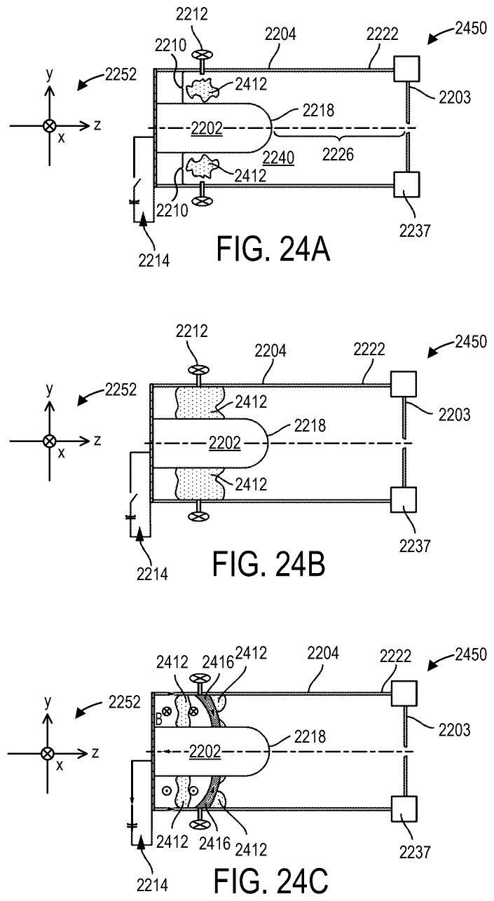

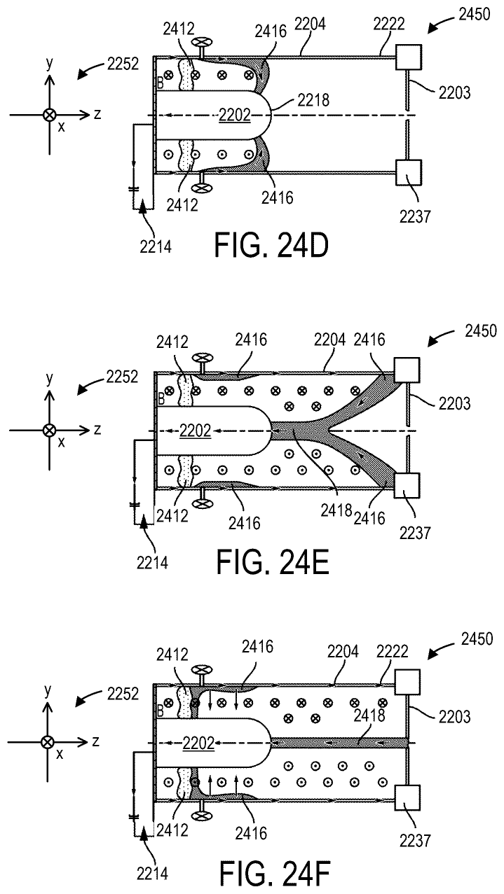

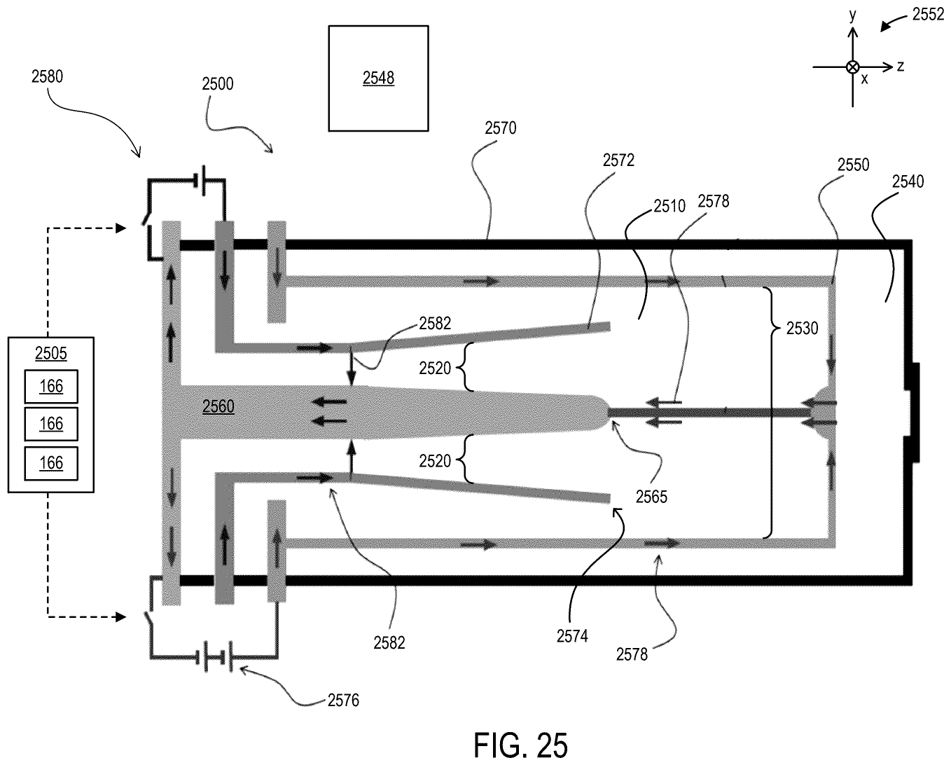

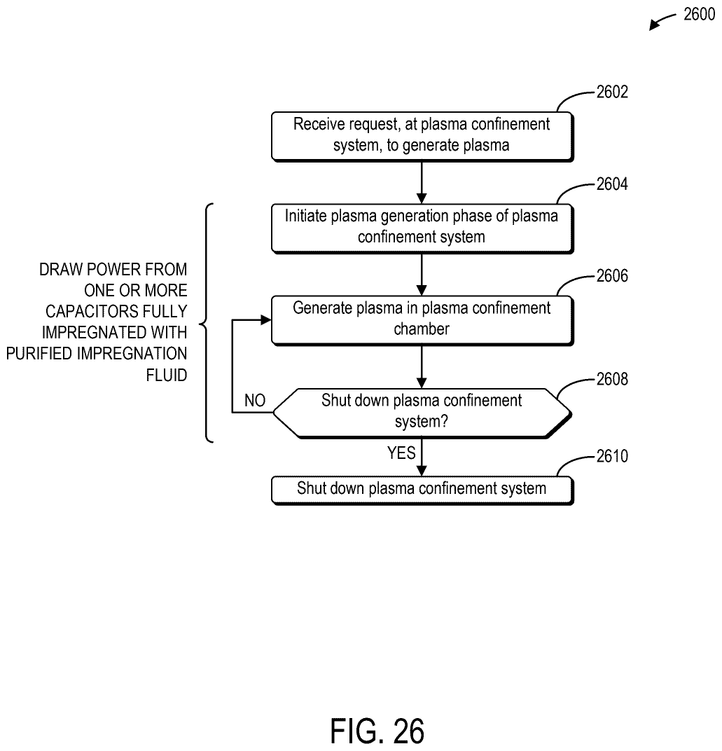

Referring now to FIG. 22, a schematic cross-sectional diagram of a plasma confinement system 2200, such as may be included within a thermonuclear fusion energy system, device, reactor, power plant, or other such apparatus or system, is shown in accordance with at least one embodiment. The plasma confinement system 2200 may generate a plasma within an assembly, or compression, region 2226 of a plasma confinement chamber 2240, the plasma confined, compressed, and sustained by an axially symmetric magnetic field. The axially symmetric magnetic field may be stabilized by a sheared ion velocity flow driven by electrical discharge between one or more pairs of electrodes interfacing with the plasma confinement chamber 2240. One or more aspects of the plasma confinement system 2200 may be readily transferable to other plasma confinement configurations, such as plasma confinement system 2500 described in detail below with reference to FIG. 25. Operation of plasma confinement systems described herein, such as the plasma confinement systems 2200 and 2500, are further described in detail below with reference to FIG. 26. FIGS. 23-24F discuss further operational details of the plasma confinement system 2200.

A set of Cartesian coordinate axes 2252 is shown in FIG. 22 for contextualizing positions of the various components of the plasma confinement system 2200 and for comparing between the various views of FIGS. 22 and 24A-24F. Specifically, x-, y-, and z-axes are provided which are mutually perpendicular to one another, where the y- and z-axes define a plane of the schematic cross-sectional diagram shown in FIG. 22 and the x-axis is perpendicular thereto. In some embodiments, a direction of gravity may be parallel to and coincident with any direction in the plane of the schematic cross-sectional diagram of FIG. 22. For example, the direction of gravity may be parallel and coincident with a positive direction of the z-axis. In additional or alternative embodiments, the direction of gravity may be within a plane defined by the x- and y-axes (e.g., parallel and coincident with a negative direction of the y-axis).

In an example embodiment, the plasma confinement system 2200 may include an inner electrode 2202 and an outer electrode 2204 that substantially surrounds the inner electrode 2202 (when the term “substantially” is used herein, it is meant that the recited characteristic, parameter, or value need not be achieved exactly, but that deviations or variations, including, for example, tolerances, measurement error, measurement accuracy limitations, and other factors known to those of skill in the art, may occur in amounts that do not preclude the effect the characteristic was intended to provide). For example, the inner electrode 2202 may be at least partially circumferentially surrounded by the outer electrode 2204, such that one end of the inner electrode 2202 (e.g., a first end 2218) may be partially or fully surrounded by the outer electrode 2204. In some embodiments, the inner electrode 2202 may have a length (e.g., parallel with the z-axis and between the first end 2218 and an opposing second end 2220) ranging from 2 cm to 1 m (e.g., 25 cm to 1 m) or more and a radius (e.g., parallel with the y-axis) ranging from 2 cm to 1 m (e.g., 25 cm to 1 m), and the outer electrode 2204 may have a length (e.g., parallel with the z-axis and between a first end 2222 and an opposing second end 2224) ranging from 50 cm to 6 m, a radius (e.g., parallel with the y-axis) ranging from 6 cm to 2 m or more, and an annular thickness (e.g., along the y-axis) ranging from 6 mm to 12 mm.

In certain embodiments, and as shown in FIG. 22, the plasma confinement system 2200 may further include an intermediate electrode 2203 that faces the inner electrode 2202. In such examples, the intermediate electrode 2203 may be referred to as an “end wall electrode” and may be arranged co-planar with a plane formed by the x- and y-axes, such that the intermediate electrode 2203 is positioned across the assembly region 2226 from the first end 2218 of the inner electrode 2202. In at least one other embodiment, and as described in greater detail with reference to FIG. 25, the intermediate electrode 2203 may be an electrode that is coaxial with the inner electrode 2202 (e.g., along the z-axis). In other embodiments, and as described in detail below with reference to FIG. 25, the intermediate electrode 2203 may substantially surround the inner electrode 2202 and the outer electrode 2204 may substantially surround the intermediate electrode 2203. For example, the inner electrode 2202 may be at least partially circumferentially surrounded by the intermediate electrode 2203 and the intermediate electrode 2203 may be at least partially circumferentially surrounded by the outer electrode 2204, such that one end of the inner electrode 2202 (e.g., the first end 2218) may be partially or fully surrounded by the intermediate electrode 2203 and one end of the intermediate electrode 2203 may be partially or fully surrounded by the outer electrode 2204.

In some embodiments, the plasma confinement chamber 2240 may be a physical structure inclusive of a volume delimited by one or more electrodes, insulators, and internal components of the plasma confinement system 2200. As such, in certain embodiments, the plasma confinement chamber 2240 may include the one or more electrodes, insulators, and internal components of the plasma confinement system 2200 which delimit the volume of the plasma confinement chamber 2240.

In an example embodiment, the outer electrode 2204 may define a radial outer boundary of the plasma confinement chamber 2240. In one example, the radial outer boundary may be cylindrical and formed as a circular cross section propagated along the z-axis, the circular cross section parallel to a plane formed by the x- and y-axes. The plasma confinement chamber 2240 may be partitioned (e.g., without any physical partition) into at least: (i) an acceleration region 2210 between the inner electrode 2202 and the outer electrode 2204; and (ii) the assembly region 2226 between the first end 2218 of the inner electrode 2202 and the intermediate electrode 2203. Alternatively, in embodiments where the intermediate electrode 2203 at least partially surrounds the inner electrode 2202, the acceleration region 2210 may be between the inner electrode 2202 and the intermediate electrode 2203, and the assembly region 2226 may be between the first end 2218 of the inner electrode 2202 and an opposing end (e.g., the first end 2222) of the outer electrode 2204. In either case, the plasma confinement system 2200 may include a plurality of electrodes (e.g., the inner electrode 2202, the intermediate electrode 2203, and the outer electrode 2204), each electrode of the plurality of electrodes arranged coaxially with respect to the assembly region 2226 (e.g., along the z-axis) and positioned so as to be exposed to the assembly region 2226 (e.g., each given electrode of the plurality of electrodes may interface with a volume of the assembly region 2226 without any intervening components or volumes, such that an electrical current can pass directly from a confined plasma to the given electrode). More specifically, the outer electrode 2204 may be positioned to define at least a portion of an outer boundary of the assembly region 2226, the inner electrode 2202 may be positioned at one end of the assembly region 2226 (e.g., coincident with the first end 2218 of the inner electrode 2202), and the intermediate electrode 2203, when included, may be positioned at the same end of the assembly region 2226 with respect to the inner electrode 2202 or an opposite end of the assembly region 2226 with respect to the inner electrode 2202 (e.g., as an end wall electrode). The plasma confinement system 2200 may be configured to sustain a Z-pinch plasma (e.g., the plasma column) within the assembly region 2226 as described below. In some embodiments, the acceleration region 2210 may have a length (e.g., parallel with the z-axis and between the second end 2224 of the outer electrode 2204 and the first end 2218 of the inner electrode 2202) ranging from 25 cm to 1.5 m and an annular thickness ranging from 2 cm to 10 cm, and the assembly region 2226 may have a length (e.g., parallel with the z-axis and between the first end 2218 of the inner electrode 2202 and the first end 2222 of the outer electrode 2204) ranging from 25 cm to 3 m.

The plasma confinement system 2200 may include one or more first valves 2206 configured to direct gas from within the inner electrode 2202 to the acceleration region 2210 and one or more second valves 2212 configured to direct gas from outside the outer electrode 2204 to the acceleration region 2210. The gas may be the fuel gas, which may be utilized to form the plasma upon release of the gas into the plasma confinement chamber 2240 and application of the discharge current. As used herein, “fuel gas” may refer to any species utilized to form the plasma assembly. As such, the fuel gas may include neutral gas species, such as dihydrogen [e.g., hydrogen (H₂), deuterium (D₂), and/or tritium (T₂)], other protium-, deuterium- and/or tritium-containing species, ³He, ⁶Li, ¹¹B, etc., and/or pre-ionized gas species (e.g., such as introduced via “direct plasma injection” or “plasma injection” configurations). For example, the pre-ionized gas species may include one or more of dihydrogen [e.g., hydrogen (H₂), deuterium (D₂), and/or tritium (T₂)], other protium-, deuterium-, and/or tritium-containing species, ³He, ⁶Li, or ¹¹B, among others.

The plasma confinement system 2200 may include a first power supply 2214 configured to apply a voltage (e.g., ranging from 2 kV to 100 kV in some examples or from 2 kV to 50 kV in other examples or from 1 kV to 40 kV in other examples) between the inner electrode 2202 and the outer electrode 2204 (e.g., so as to drive an electric current from the outer electrode 2204 to the inner electrode 2202 in some embodiments or from the inner electrode 2202 to the outer electrode 2204 in other embodiments). In some embodiments, the plasma confinement system 2200 may further include a second power supply 2215 configured to apply a voltage (e.g., ranging from 2 kV to 100 kV in some examples or from 2 kV to 50 kV in other examples or from 1 kV to 40 kV in other examples) between the inner electrode 2202 and the intermediate electrode 2203 (e.g., so as to drive an electric current from the inner electrode 2202 to the intermediate electrode 2203 in some embodiments or from the intermediate electrode 2203 to the inner electrode 2202 in other embodiments). In certain embodiments, the plasma confinement system 2200 may operate with only one of the first and second power supplies 2214, 2215. In other embodiments, the plasma confinement system 2200 may operate at least with both of the first and second power supplies 2214, 2215.

In some embodiments, one or both of the first and second power supplies 2214, 2215 may include a switching pulsed direct current (switching pulsed-DC) power supply including an energy source. In at least one embodiment, the energy source may be a bank 2205 of the capacitors 166 of FIGS. 1-15, which may be similarly configured to the capacitor 1900 of FIG. 19. Although depicted as a single capacitor bank 2205 in FIG. 22, in other embodiments, each of the first and second power supplies 2214, 2215 may include a respective capacitor bank. Moreover, while the capacitor bank 2205 is depicted with three capacitors 166, the capacitor bank 2205 may include various quantities of the capacitors 166, such as 2, 10, or 20. In addition, in other embodiments, the capacitor bank 2205 may be similarly used to supply power to other types of plasma confinement systems, in addition to Z-pinch plasma confinement systems. For example, the capacitor bank 2205 may be an energy source for a tokamak, a toroidal pinch, or any other type of magnetic, magneto-inertial, magnetized target, or inertial plasma confinement system.

As described above with reference to FIGS. 1-15 and 20-21, the capacitors 166 may be prepared and assembled via the impregnation system 100. One or both of the first and second power supplies 2214, 2215 may further include a switch (e.g., a spark gap, an ignitron, a semiconductor switch, or the like), and a pulse shaping network (including, e.g., inductors, resistors, diodes, and the like). In some embodiments, one or both of the first and second power supplies 2214, 2215 may be voltage-controlled. In other embodiments, one or both of the first and second power supplies 2214, 2215 may be current-controlled. In some embodiments, other suitable types of power supplies may be used as one or both of first and second power supplies 2214, 2215, including DC and alternating current (AC) power supplies (e.g., DC grids, voltage source converters, homopolar generators, and the like).

The inner electrode 2202 may include an electrically conducting shell having a modified cylindrical body 2216 (e.g., a substantially cylindrical body with a tapered, rounded base at the first end 2218). Specifically, the inner electrode 2202 may include the first end 2218 (e.g., a tapered, rounded base) and the opposing second end 2220 (e.g., a substantially flat, circular base). For instance, the inner electrode 2202 may include a nosecone 2244 positioned at the first end 2218, the nosecone 2244 exposed to the assembly region 2226 so as to be intersected by an axis (e.g., a longitudinal axis) of the confined plasma coaxial with each electrode of the plurality of electrodes (e.g., parallel to the z-axis). The inner electrode 2202 may further include one or more conduits or channels 2242 for routing gas (e.g., the fuel gas) from the one or more first valves 2206 to the acceleration region 2210, for example, during operation of the plasma confinement system 2200 to generate thermonuclear fusion.

The outer electrode 2204 may include an electrically conducting shell having a substantially cylindrical body 2228. Specifically, the outer electrode 2204 may include the first end 2222 (e.g., a substantially flat, circular base) and the opposing second end 2224 (e.g., a substantially flat, circular base). The outer electrode 2204 may surround much (e.g., a majority) of the inner electrode 2202. In an example embodiment, the inner electrode 2202 and the outer electrode 2204 may be concentric and have radial symmetry with respect to the z-axis. The first end 2218 of the inner electrode 2202 may be between the first end 2222 of the outer electrode 2204 and the second end 2224 of the outer electrode 2204. The outer electrode 2204 may further include one or more conduits or channels (not shown at FIG. 22) for routing gas (e.g., the fuel gas) from the one or more second valves 2212 to the acceleration region 2210, for example, during operation of the plasma confinement system 2200 to generate thermonuclear fusion.

The intermediate electrode 2203 may include an electrically conducting material. In some embodiments, the intermediate electrode 2203 may be substantially disc-shaped. For example, in such embodiments, the intermediate electrode 2203 may be an end wall electrode. In other embodiments, the intermediate electrode may have a substantially cylindrical body concentric with each of the inner electrode 2202 and the outer electrode 2204 and having radial symmetry with respect to the z-axis. For example, in such embodiments, the intermediate electrode 2203 may be a coaxial electrode (e.g., positioned coaxially with respect to the inner electrode 2202 and/or the outer electrode 2204).

The one or more first valves 2206 may take the form of so-called “puff valves” (e.g., operable to provide fuel gas for formation of a plasma or increase a density of the as-generated plasma via gas puffing) or plasma injectors. In additional or alternative embodiments, the one or more first valves 2206 may include at least one electrically actuated valve, such as a solenoid-driven valve. However, the one or more first valves 2206 are not limited to such configurations and may include any type of valve configured to direct gas (e.g., H₂, D₂, and/or T₂) from within the inner electrode 2202 to the acceleration region 2210.

In some embodiments, the one or more first valves 2206 may include at least one gas-puff valve (e.g., to provide neutral gas to the acceleration region 2210) and/or at least one plasma injector (e.g., to provide pre-ionized gas to the acceleration region 2210) installed as a regular array or arrays along the inner electrode 2202 (e.g., regularly distributed around a central axis of the acceleration region 2210, that is, parallel to the z-axis). As shown in FIG. 22, the one or more first valves 2206 may be positioned (e.g., positioned axially) between the first end 2218 of the inner electrode 2202 and the second end 2220 of the inner electrode 2202. Alternatively, the one or more first valves 2206 may be located at (e.g., directly adjacent to) the first end 2218 of the inner electrode 2202 or the second end 2220 of the inner electrode 2202. In FIG. 22, each of the one or more first valves 2206 is arranged within (e.g., positioned inside and on an inner surface of) the inner electrode 2202, but other examples are possible (e.g., positioned outside and on an outer surface of the inner electrode 2202). The one or more first valves 2206 may be electrically actuatable in that the one or more first valves 2206 may be operated by providing the one or more first valves 2206 with a control voltage, as described below.

In an example embodiment, the acceleration region 2210 may have a substantially annular cross section defined by the shapes of the inner electrode 2202 and the outer electrode 2204. Specifically, the inner electrode 2202 may define a radial inner boundary of the acceleration region 2210 and the outer electrode 2204 may define a radial outer boundary of the acceleration region 2210. In one example, each of the radial inner boundary and the radial outer boundary may be cylindrical and formed as a circular cross section propagated along the z-axis, the circular cross section parallel to the plane formed by the x- and y-axes. In other embodiments, the substantially annular cross section of the acceleration region 2210 may be defined by the shapes of the inner electrode 2202 and the intermediate electrode 2203 (e.g., the inner electrode 2202 may defined the radial inner boundary and the intermediate electrode 2203 may define the radial outer boundary).

In the same manner as the one or more first valves 2206, the one or more second valves 2212 may take the form of “puff valves” or plasma injectors. In additional or alternative embodiments, the one or more second valves 2212 may include at least one electrically actuated valve, such as a solenoid-driven valve. However, the one or more second valves 2212 are not limited to such configurations and may include any type of valve configured to direct gas (e.g., H₂, D₂, and/or T₂) from outside the outer electrode 2204 (or the intermediate electrode 2203) to the acceleration region 2210.

In some embodiments, the one or more second valves 2212 may include at least one gas-puff valve (e.g., to provide neutral gas to the acceleration region 2210) and/or at least one plasma injector (e.g., to provide pre-ionized gas to the acceleration region 2210) installed as a regular array or arrays along the outer electrode 2204 (e.g., regularly distributed around the acceleration region 2210). As shown in FIG. 22, the one or more second valves 2212 may be positioned (e.g., positioned axially) between the first end 2222 of the outer electrode 2204 and the second end 2224 of the outer electrode 2204. Alternatively, the one or more second valves 2212 may be located at (e.g., directly adjacent to) the first end 2222 of the outer electrode 2204 or the second end 2224 of the outer electrode 2204. In FIG. 22, each of the one or more second valves 2212 is arranged around (e.g., positioned outside and on an outer surface of) the outer electrode 2204, but other examples are possible (e.g., positioned within the plasma confinement chamber 2240, such as on an inner surface of the outer electrode 2204 or on an inner surface of the intermediate electrode 2203). Moreover, in FIG. 22, each of the one or more first valves 2206 is axially aligned with each of the one or more second valves 2212, but other examples are possible. The one or more second valves 2212 may be electrically actuatable in that the one or more second valves 2212 may be operated by providing the one or more second valves 2212 with a control voltage, as described below.

In some embodiments, gas-puff valves and/or plasma injectors included in the one or more first valves 2206 and/or the one or more second valves 2212 may be electronically triggered to independently deliver a “puff” of filling neutral and/or pre-ionized gas for a duration lasting up to several hundred μs (e.g., up to 1 ms). An amount of filling gas (also referred to herein as “fuel gas”) delivered (e.g., in the “puff”) may also be controlled by adjustments of a filling gas pressure supplied to the gas-puff valves and/or plasma injectors (e.g., to individual or all of the gas-puff valves and/or plasma injectors or subsets thereof). In addition, different gas-puff valves and/or plasma injectors (or different combinations of multiple gas-puff valves and/or plasma injectors) may be fed by different fill gas mixtures having, for example, different elemental ratios of filling gases and/or different isotopic ratios (e.g., adjustable D₂/T₂ molecular ratios). In some embodiments, the gas-puff valves and/or plasma injectors may be uniform (e.g., all of the same type/size with substantially the same operational settings). In other embodiments, different gas-puff valves and/or plasma injectors may be used for different locations. In additional or alternative embodiments, the gas-puff valves and/or plasma injectors may control a flow of gas into the acceleration region 2210 via a manifold including multiple ports providing passage into the acceleration region 2210. In such embodiments, the ports of the manifold may be uniform or may vary in configuration (e.g., to deliver different amounts of gas to different locations of the acceleration region 2210 when a respective gas-puff valve or plasma injector is open).

Similar to neutral gas injection via gas-puff valves, (pre-) ionized gas or plasma may be injected using combinations or manifolds of variously located plasma injectors fluidically coupled to respective plasma generators or guns which generate the plasma prior to injection into the acceleration region 2210. In some embodiments, the plasma may be sourced from a gas-injected washer plasma gun and/or a plasma thruster (e.g., a Hall effect thruster or a magnetohydrodynamic thruster), or, if the plasma is magnetized, from a high-power helicon plasma source, a radio frequency plasma source, a plasma torch, and/or a laser-based plasma source. Plasmas formed from gas mixtures may also be created and injected in a manner similar to neutral gas injection. Plasma injection may provide a finer control of an eventual axial plasma distribution as well as a shear flow profile thereof, which in turn may allow for higher fidelity control of plasma stability and lifetime. Additional control of plasma injection may be provided due to the plasma particles being charged particles that may be accelerated by electric fields created by a variable electrical bias (or voltage) on injection electrodes. Thus, a speed of the injected plasma may be finely controlled to allow for fine adjustment and optimization of breakdown of any neutral gas present (e.g., in the acceleration region 2210). Moreover, the injected plasma may travel at faster velocities than injected neutral gas, which may travel in a nearly static fashion (relative to the injected plasma) during Z-pinch discharge pulses. As such, relative to neutral gas injection, plasma injection may provide pre-ionized fuel “on demand” (e.g., more immediately), for example, to replenish the fuel gas during Z-pinch discharge pulses.

In some embodiments, the pre-ionized gas may be generated as an unmagnetized plasma, e.g., so as to avoid interaction between a magnetic field of the pre-ionized gas and a magnetic field of the acceleration region 2210. In other embodiments, the pre-ionized gas may be generated as a magnetized plasma, e.g., so as to align the magnetic field of the pre-ionized gas to be parallel with the magnetic field of the acceleration region 2210 and/or be adjustable to provide a desired magnetic flux profile at an injection point of the pre-ionized gas.

In some embodiments, plasma to be injected into the acceleration region 2210 may be generated by pre-ionizing neutral gas with a spark plug or via inductive ionization. More broadly, the gas-puff valves and/or plasma injectors may include one or more electrode plasma injectors and/or one or more electrodeless plasma injectors. In examples wherein the one or more electrode plasma injectors are included, the plasma to be injected into the acceleration region 2210 may be generated, at least in part, by electrode discharge. In additional or alternative examples wherein the one or more electrodeless plasma injectors are included, the plasma to be injected into the acceleration region 2210 may be generated, at least in part, by inductive discharge produced by an external coil window (e.g., a radio-frequency antenna operating at 400 kHz, 13.56 MHz, 2.45 GHZ, and/or other frequencies permitted for use in a given local jurisdiction, such as within frequency ranges permitted by the Federal Communications Commission). In some embodiments, neutral gas for pre-ionization may be limited by a configuration of a neutral gas reservoir (e.g., a gas source 2230) and/or neutral gas conductance to a selected plasma injector configuration.

In some embodiments, axial distribution of the injected plasma may be ensured via an axisymmetric plasma injector configuration. In at least one embodiment, eight plasma injectors may be respectively positioned at eight equally spaced ports of the manifold. The eight ports may each be configured at an oblique angle (e.g., between 5° and 90° with respect to the central axis of the acceleration region 2210) with respect to a housing of the acceleration region 2210 (e.g., the surrounding outer electrode 2204). In one example, the oblique angle may be 45° with respect to the central axis of the acceleration region 2210. In some embodiments, the eight ports may be configured at a single axial position along the central axis of the acceleration region 2210 (that is, the eight ports may be equally spaced about a circumference or other perimeter of the acceleration region 2210 at the axial position). In other embodiments, the ports may include multiple sets of eight ports, with each set of eight ports being equally spaced about a different axial position along the central axis of the acceleration region 2210. In an example embodiment, the sets of eight ports may be configured as interleaved pairs of sets, wherein a first set of eight ports may be positioned at a first axial location and a second set of eight ports may be positioned at a second, different axial location and rotated relative to the first set such that each port of the second set is positioned between a pair of ports of the first set with respect to the circumference of the acceleration region 2210. Specifically, in such an embodiment, each port of the first set of eight ports may be spaced around the circumference of the acceleration region 2210 every 45°, and each port of the second set of eight ports may be spaced around the circumference of the acceleration region 2210 every 45° offset (rotated) from the first set of ports by 22.5°, such that one port of the first and second sets is provided around the circumference of the acceleration region 2210 every 22.5°. In additional or alternative embodiments, plasma injection may be performed azimuthally, e.g., along a chord perpendicular to the central axis of the acceleration region 2210, so as to generate an azimuthal flow within the acceleration region 2210. In some embodiments, additional gas-puff valves and/or plasma injectors may be included to allow for injection of more fuel gas (e.g., for longer lasting pinch discharges) and control of an axial pressure distribution of the fuel gas in the acceleration region 2210 (e.g., for additional enhancement of the sheared ion velocity flow duration). In additional or alternative embodiments, the valves may be configured differently (e.g., asymmetrically distributed azimuthally and/or with different angular distributions) with other variations to achieve a substantially equivalent profile by compensating for effects of the variations.

In some embodiments, injecting the acceleration region 2210 with pre-ionized gas may result in plasmas having a plasma temperature in a range of 1 to 10 eV. The plasma temperature may be decreased (e.g., by reducing an amount of energy input into a process gas used to generate the pre-ionized gas) so as to increase an electrical resistivity of the pre-ionized gas and resulting plasma. Specifically, increasing the electrical resistivity may decrease a tendency of the pre-ionized gas to oppose changes in magnetic flux and thereby a tendency to oppose motion within a magnetic field present in the acceleration region 2210.

As noted above, because an injection velocity of pre-ionized gas may be significantly greater than that of neutral gas, a velocity of the plasma within the acceleration region 2210 may be up to 50×10³ m/s. In some embodiments, injection of pre-ionized gas may provide flexibility in an amount of particles injected. Specifically, in an example embodiment, an amount of pre-ionized gas particles may be injected in 1/50 of a time utilized to inject the same amount of neutral gas particles. For example, an amount of time utilized to inject 10 Torr-L of neutral gas particles (where 1 Torr-L is proportional to 2.5×10¹⁹ molecules at 273 K) may be the same amount of time utilized to inject 500 Torr-L of pre-ionized gas particles. Similarly, in some embodiments, an injection rate (or mass flow rate) of pre-ionized gas may be varied according to power supply current and voltage (that is, a waveform of an injection pulse). As an example, increasing the power supply voltage (e.g., to between 100 V and 500 V) may concomitantly increase the injection velocity. As another example, increasing the power supply current (e.g., to between 1 A and 500 A) may concomitantly increase the injection rate. In some embodiments, the power supply voltage may be increased to between 750 V and 5 kV.

As discussed above, the gas-puff valves and/or plasma injectors may be activated either individually or in groups. An initial gas load inside the acceleration region 2210 having desired axial and azimuthal profiles may be achieved by timing individual valves and/or groups of valves. Such valves (or groups thereof) may be timed in a fashion to align an arrival of the neutral and/or pre-ionized gas and/or mixtures thereof to a desired initial profile. Power supplies (e.g., power supplies 2214 and 2215 or separate, dedicated power supplies) may be timed to achieve ionization at a desired axial location and utilize the initial gas load to produce and sustain the sheared flow. In some embodiments, the power supplies may include a capacitor bank (e.g., the capacitor bank 2205) and a switch. In at least one embodiment, the capacitor bank 2205 may include one or more of the capacitors 166 prepared and assembled as described above via the impregnation system 100 of FIGS. 1-15. In other embodiments, other suitable types of power supplies may be used, including flywheel power supplies.

Various combinations of (neutral gas) gas-puff valves with plasma injectors may be activated to achieve a desired level of power output. Moreover, plasma may be injected into the acceleration region 2210 significantly (e.g., ˜100×) faster than puffed neutral gas. A combination of such different injection speeds allowed by acceleration of plasma injection with neutral gas injection provides an even larger parameter space for optimization. Additionally, plasma injectors may serve to inject mass and precisely control locations of neutral gas ionization.

In an example embodiment, the first power supply 2214 and the second power supply 2215 may take the form of respective capacitor banks 2205, including one or more of the capacitors 166, each capable of storing up to 10 MJ (e.g., 0.1 to 10 MJ) or more. In one such embodiment, the first power supply 2214 and the second power supply 2215 may take the form of respective capacitor banks 2205 capable of storing up to 100-200 kJ and 3-4 MJ, respectively.

In an example embodiment, the plasma confinement system 2200 may include the gas source 2230 (e.g., a pressurized storage tank) and one or more first regulators 2232 respectively configured to control gas flow from the gas source 2230 through the one or more first valves 2206. Respective couplings (e.g., piping) between the one or more first regulators 2232 and the one or more first valves 2206 are omitted in FIG. 22 for clarity.

In an example embodiment, the plasma confinement system 2200 may include one or more second regulators 2234 respectively configured to control gas flow from the gas source 2230 through the one or more second valves 2212. Respective couplings (e.g., piping) between the one or more second regulators 2234 and the one or more second valves 2212 are omitted in FIG. 22 for clarity.

In some embodiments, the plasma confinement system 2200 may include a first insulator 2236 (e.g., having an annular cross section) between the inner electrode 2202 and the outer electrode 2204 to maintain electrical isolation between the inner electrode 2202 and the outer electrode 2204. In other embodiments, such as when the inner electrode 2202 is at least partially surrounded by the intermediate electrode 2203, the first insulator 2236 may be positioned between the inner electrode 2202 and the intermediate electrode 2203 to maintain electrical isolation between the inner electrode 2202 and the intermediate electrode 2203. In an example embodiment, the first insulator 2236 may be formed from an electrically insulating material such as a glass, a ceramic, or a glass-ceramic material. In some embodiments, one or more valves (e.g., gas-puff valves and/or plasma injectors) may extend through or be provided in place of the first insulator 2236 to inject neutral gas and/or pre-ionized gas at an end of the acceleration region 2210 opposite to the first end 2218 of the inner electrode 2202.

In an example embodiment, the plasma confinement system 2200 may include a second insulator 2237 (e.g., having an annular cross section) between the intermediate electrode 2203 and the outer electrode 2204 to maintain electrical isolation between the intermediate electrode 2203 and the outer electrode 2204. In an example embodiment, the second insulator 2237 may be formed from an electrically insulating material such as SiC, a ceramic, or a glass-ceramic material.

In an example embodiment, the plasma confinement system 2200 may include a vacuum chamber 2238 that at least partially surrounds the inner electrode 2202, the intermediate electrode 2203, and/or the outer electrode 2204. In the example embodiment depicted in FIG. 22, the vacuum chamber 2238 entirely surrounds each of the inner electrode 2202, the intermediate electrode 2203, and the outer electrode 2204 (and thereby the plasma confinement chamber 2240). In an example embodiment, the vacuum chamber 2238 may be formed as a stainless steel pressure vessel. In some embodiments, a pressure inside the vacuum chamber 2238 may range from 10⁻⁹ Torr to 20 Torr (e.g., 10⁻⁹ Torr to 10⁻³ Torr).

In an example embodiment, the plasma confinement system 2200 may include a controller or other computing device 2248, which may include non-transitory memory on which executable instructions may be stored. The executable instructions may be executed by one or more processors of the controller 2248 to perform various functionalities of the plasma confinement system 2200. Accordingly, the executable instructions may include various routines for operation, maintenance, and testing of the plasma confinement system 2200. The controller 2248 may further include a user interface at which an operator of the plasma confinement system 2200 may enter commands or otherwise modify operation of the plasma confinement system 2200. The user interface may include various components for facilitating operator use of the plasma confinement system 2200 and for receiving operator inputs (e.g., requests to generate plasma for thermonuclear fusion, etc.), such as one or more displays, input devices (e.g., keyboards, touchscreens, computer mice, depressible buttons, mechanical switches other mechanical actuators, etc.), lights, etc. The controller 2248 may be communicably coupled to various components (e.g., valves, power supplies, etc.) of the plasma confinement system 2200 to command actuation and use thereof (wired and/or wireless communication paths between the controller 2248 and the various components are omitted from FIG. 22 for clarity).

Referring now to FIGS. 23-24F, operational aspects of a plasma confinement system, such as the plasma confinement system 2200 described in detail above with reference to FIG. 22, are illustrated in accordance with at least one embodiment. Specifically, in FIG. 23, a block diagram of a method 2300 for operating the plasma confinement system is shown, and, in FIGS. 24A-24F, schematic cross-sectional diagrams of a portion 2450 of the plasma confinement system 2200 of FIG. 22 and functionality thereof are respectively shown. Accordingly, FIGS. 22 and 24A-24F, viewed together, illustrate at least some of the aspects of the method 2300 as described below. In certain embodiments, systems and components described in detail herein with reference to FIGS. 22 and 24A-25 can perform part or all of the method 2300 or be integrated into the method 2300. Accordingly, in such embodiments, the plasma confinement system to be operated as described in detail below may include one or more, or all, components from any of the plasma confinement systems 2200 or 2500. Accordingly, in certain embodiments, the plasma confinement system to be operated may be configured as a Z-pinch plasma confinement system. In an example embodiment, operation of the plasma confinement system (e.g., the plasma confinement system 2200 or the plasma confinement system 2500) by performing the method 2300 may include initiating and driving a sheared ion velocity flow therein for stabilization of Z-pinch discharge.

In some embodiments, the method 2300, or a portion thereof, may be implemented as executable instructions stored in non-transitory memory of a computing device, e.g., the controller 2248 of FIG. 22 or the controller 2548 of FIG. 25, such as a controller communicably coupled to the plasma confinement system. Moreover, in certain embodiments, additional or alternative sequences of steps may be implemented as executable instructions on such a computing device, where individual steps discussed with reference to the method 2300 may be added, removed, substituted, modified, or interchanged. As an example, the method 2300 may be performed as a portion of the method 2600 of FIG. 26, such as in place of the blocks 2604 and 2606 as described in detail with reference to FIG. 26.

At block 2302, the method 2300 may include directing gas, via one or more first valves, from within an inner electrode to an acceleration region of a plasma confinement chamber. In an example embodiment, the acceleration region may be located between the inner electrode and an outer electrode that substantially surrounds the inner electrode. In other embodiments, the acceleration region may be located between the inner electrode and an intermediate electrode that substantially surrounds the inner electrode, the outer electrode substantially surrounding the intermediate electrode.

For example, and as shown in FIGS. 24A and 24B, the one or more first valves 2206 may direct a gas 2412 from within the inner electrode 2202 to the acceleration region 2210 between the inner electrode 2202 and the outer electrode 2204 that substantially surrounds the inner electrode 2202. Specifically, FIG. 24A illustrates an initial amount of the gas 2412 entering the acceleration region 2210 and FIG. 24B illustrates an additional amount of the gas 2412 entering the acceleration region 2210. As shown in FIG. 24A, the acceleration region 2210 may be included, along with the assembly region 2226, in the plasma confinement chamber 2240.

In some embodiments, directing the gas 2412 via the one or more first valves 2206 may include providing (e.g., via a power supply such as a capacitor bank that is not shown at FIGS. 24A-24F) a first valve voltage to the one or more first valves 2206 (e.g., to control terminals of the one or more first valves 2206) followed by providing a second valve voltage (e.g., via a DC power supply) to the one or more first valves 2206. In an example embodiment, the first valve voltage may be greater than the second valve voltage and the second valve voltage may be provided immediately (e.g., substantially immediately) after providing the first valve voltage.

At block 2304, the method 2300 may include directing gas, via one or more second valves, from outside the outer electrode to the acceleration region.

For example, and as shown in FIGS. 24A and 24B, the one or more second valves 2212 may direct a portion of the gas 2412 into the acceleration region 2210.

In some embodiments, directing the gas 2412 via the one or more second valves 2212 may include providing (e.g., via a power supply such as the capacitor bank 2205 depicted in FIG. 22) a third valve voltage to the one or more second valves 2212 (e.g., to control terminals of the one or more second valves 2212) followed by providing a fourth valve voltage (e.g., via a DC power supply) to the one or more second valves 2212. In an example embodiment, the third valve voltage may be greater than the fourth valve voltage and the fourth valve voltage may be provided immediately (e.g., substantially immediately) after providing the third valve voltage.

After operation of the one or more first valves 2206 and the one or more second valves 2212, a gas pressure at, e.g., directly adjacent to (upon release) or within (such as within a plenum of, when present), each of the one or more first valves 2206 and the one or more second valves 2212 may be up to 5800 Torr, such as within a range of 1000 to 5800 Torr (e.g., 5450 to 5550 Torr), prior to applying a voltage between the inner electrode 2202 and the outer electrode 2204 via the first power supply 2214. Correspondingly, after operation of the one or more first valves 2206 and the one or more second valves 2212, a gas pressure within the acceleration region 2210 may be up to 5800 Torr, such as within the range of 1000 to 5800 Torr (e.g., 5450 to 5550 Torr), prior to applying the voltage between the inner electrode 2202 and the outer electrode 2204 via the first power supply 2214. In an example embodiment, the gas pressure within the acceleration region 2210 may decrease with increasing distance from a point of gas insertion and with passage of time after gas is no longer introduced to the acceleration region 2210.

At block 2306, the method 2300 may include applying, via a first power supply, a voltage between the inner electrode and the outer electrode to convert at least a portion of the directed gas into a plasma having a substantially annular cross section, the plasma flowing axially within the acceleration region toward a first end of the inner electrode and a first end of the outer electrode.

For example, and as shown in FIGS. 24C and 24D, the first power supply 2214 may apply the voltage between the inner electrode 2202 and the outer electrode 2204 to convert at least a portion of the gas 2412 into a plasma 2416 having a substantially annular cross section. The voltage applied by the first power supply 2214 between the inner electrode 2202 and the outer electrode 2204 may result in a radial electric field within the acceleration region 2210 up to 500 kV/m (e.g., within a range of 30 kV/m to 500 kV/m). Due to a magnetic field being generated by a current traveling through the plasma 2416, the plasma 2416 may flow axially within the acceleration region 2210 toward the first end 2218 of the inner electrode 2202 and the first end 2222 of the outer electrode 2204 (as shown in FIGS. 24C and 24D).

At block 2308, the method 2300 may include applying, via a second power supply, a voltage between the inner electrode and the intermediate electrode to establish a plasma column (e.g., a Z-pinch plasma) that flows between the intermediate electrode and the first end of the inner electrode (e.g., when the intermediate electrode is configured as an end wall electrode). In an example embodiment, the intermediate electrode may be positioned at a first end of the outer electrode. In other embodiments, and as discussed above, the intermediate electrode may substantially surround the inner electrode, and the outer electrode may substantially surround the intermediate electrode.

For example, and as shown in FIGS. 24E and 24F, the second power supply (e.g., the second power supply 2215 as described in detail above with reference to FIG. 22; omitted in FIGS. 24A-24F for clarity) may apply a voltage between the inner electrode 2202 and the intermediate electrode 2203 to confine the plasma 2416 and establish a plasma column 2418 (also referred to herein as a Z-pinch plasma 2418) that flows between the intermediate electrode 2203 and the first end 2218 of the inner electrode 2202. As shown, the plasma column 2418 may be established when the plasma 2416 moves beyond the acceleration region 2210. Specifically, the plasma column 2418 may flow into the assembly region 2226 between the first end 2218 of the inner electrode 2202 and the intermediate electrode 2203. In some embodiments, such as when the inner electrode 2202 functions as a cathode and the intermediate electrode 2203 and/or the outer electrode 2204 function as an anode, each of a discharge current forming the plasma 2418 and a sheared axial (ion velocity) flow stabilizing the discharge current may flow from the first end 2218 of the inner electrode 2202 to the intermediate electrode 2203. In other embodiments, such as when the inner electrode 2202 functions as the anode and the intermediate electrode 2203 and/or the outer electrode 2204 function as the cathode, the discharge current may flow from the intermediate electrode 2203 to the first end 2218 of the inner electrode 2202 and the sheared axial flow may flow from the first end 2218 of the inner electrode 2202 to the intermediate electrode 2203. In some embodiments, to augment the sheared flow profile created by neutral gas injection, injection of pre-ionized gas using plasma injectors, plasma guns, or ion sources may be employed in conjunction. In such embodiments, accordingly, plasma injection may occur rapidly and on the same scale as the blocks 2302 and 2304, and may be used to control formation/initialization and dynamics of the plasma 2418.

In an example embodiment, the plasma column 2418 may exhibit the sheared axial flow and have a radius up to 5 mm, such as between 0.1 and 5 mm (e.g., between 0.05 and 5 mm), an ion temperature up to 50000 eV, such as between 900 and 30000 eV (e.g., 900 to 2000 eV), an electron temperature greater than 500 eV (e.g., 500 to 50000 eV), an ion number density greater than 1×10²³ ions/m³ and/or an electron number density greater than 1×10²³ electrons/m³, and/or a magnetic field over 8 T, and/or may be stable for at least 1 μs, such as between 5 and 10 μs, or at least 10 μs, and/or up to 200 μs, or up to 500 μs, or up to 1 ms. It should be noted that such ranges are exemplary and may be modified based on an operating mode of the plasma confinement system 2200 or based on modifications to a size, function, configuration, etc. of the plasma confinement system 2200. For example, if the size of the plasma confinement system 2200 increases, such ranges may scale proportionally (e.g., linearly, exponentially, etc.).

It should be noted that the blocks 2306 and 2308 may be implemented by other means of controlling (a) the voltage between the inner electrode 2202 and the outer electrode 2204 and (b) the voltage between the inner electrode 2202 and the intermediate electrode 2203, as one of skill in the art will recognize. For example, the capacitor bank 2205 (as shown in FIG. 22) may provide a voltage between the intermediate electrode 2203 and the outer electrode 2204, instead of between the inner electrode 2202 and the intermediate electrode 2203. The capacitor bank may include, for example, one or more capacitors fully (or substantially fully) impregnated with a purified impregnation fluid, such as an oil or a dielectric.

Referring now to FIG. 25, a schematic cross-sectional diagram of a plasma confinement system 2500, such as may be included within a thermonuclear fusion energy system, device, reactor, power plant, or other such apparatus or system, is shown in accordance with at least one embodiment. The plasma confinement system 2500 may generate plasma (e.g., a plasma column) within an assembly, or compression, region 2530 of a plasma confinement chamber 2510, the plasma confined, compressed, and sustained by an axially symmetric magnetic field. The axially symmetric magnetic field may be stabilized by a sheared ion velocity flow driven by electrical discharge between one or more pairs of electrodes interfacing with the plasma confinement chamber 2510.

The plasma confinement system 2500 may be assembled and configured similarly to the plasma confinement system 2200 and may operate in a substantially similar manner in practice. The primary differences between the plasma confinement system 2200 as depicted in FIG. 22 and the plasma confinement system 2500 as depicted in FIG. 25 include relative positioning and spatial configuration of the intermediate electrode 2203 (in FIG. 22) and relative positioning and spatial configuration of an intermediate electrode 2572 (in FIG. 25), which will be discussed in greater detail below. Excepting certain assembly and operational aspects which may arise from such differences, the description provided above with reference to FIGS. 22-24F may be additionally applied to the embodiment depicted in FIG. 25. In certain embodiments, additional subsystems and/or functionalities may also be included in the plasma confinement system 2500 which were not described in detail above with reference to FIGS. 22-24F and which may be additionally applied to the embodiments depicted in FIGS. 22-24F.

A set of Cartesian coordinate axes 2552 is shown in FIG. 25 for contextualizing positions of the various components of the plasma confinement system 2500 and for comparing between the views of FIGS. 22 and 25. Specifically, x-, y-, and z-axes are provided which are mutually perpendicular to one another, where the y- and z-axes define a plane of the schematic cross-sectional diagram shown in FIG. 25 and the x-axis is perpendicular thereto. In some embodiments, a direction of gravity may be parallel to and coincident with any direction in the plane of the schematic cross-sectional diagram of FIG. 25. For example, the direction of gravity may be parallel and coincident with a positive direction of the z-axis. In additional or alternative embodiments, the direction of gravity may be within a plane defined by the x- and y-axes (e.g., parallel and coincident with a negative direction of the y-axis).

In an example embodiment, the plasma confinement system 2500 may include an outer electrode 2550 separated physically and functionally from an external vacuum boundary 2570, the external vacuum boundary 2570, together with portions of an inner electrode 2560, forming a vacuum vessel 2540 as a low pressure container including the plasma confinement chamber 2510. The intermediate electrode 2572 may be positioned so as to have a radius in between a radius of the inner electrode 2560 and a radius of the outer electrode 2550. Specifically, the intermediate electrode 2572 may substantially surround the inner electrode 2560 and the outer electrode 2550 may substantially surround the intermediate electrode 2572. For example, the inner electrode 2560 may include one end 2565 that is at least partially surrounded by the intermediate electrode 2572 and the intermediate electrode 2572 may include one end 2574 that is at least partially surrounded by the outer electrode 2550.

In certain embodiments, the outer electrode 2550 may include a solid conductive shell and a flowing electrically conductive material disposed on the solid conductive shell. In at least one embodiment, the flowing electrically conductive material may have a liquid composition, e.g., be at least partially in a liquid state, under one or more operating conditions of the plasma confinement system 2500. In various examples, the flowing electrically conductive material can take the form of eutectics, alloys, or mixtures of one or more of lithium, lead, or tin, among others. In at least one embodiment, the flowing electrically conductive material may be an alloy including at least Li and Pb and which is at least partially in a liquid state under one or more operating conditions of the plasma confinement system 2500. A pumping system (not shown at FIG. 25) may be fluidically coupled to the plasma confinement chamber 2510 and configured to circulate the flowing electrically conductive material therethrough (e.g., under one or more operating conditions of the plasma confinement system 2500).

The plasma confinement system 2500 may incorporate at least two functionally separate power supplies, e.g., at least one primary power supply 2576 primarily arranged and controlled to drive a Z-pinch (discharge) current 2578 (I_{pinch}), and at least one additional power supply 2580 primarily arranged and controlled to drive a residual current 2582. In some embodiments, the at least one primary power supply 2576 may be separate power supply device(s) from the at least one additional power supply 2580. In other embodiments, the at least one primary power supply 2576 and the at least one additional power supply 2580 may be components of the same power supply device.

In at least one embodiment, the at least one primary power supply 2576 and the at least one additional power supply 2580 may include a capacitor bank 2505 of one or more of the capacitors 166 of FIGS. 1-15, where the capacitors 166 may be prepared and assembled as shown in FIGS. 1-15 and FIGS. 20-21. In at least some embodiments, the capacitors 166 may be configured similarly to the capacitor 1900 of FIG. 19. In some embodiments, the at least one primary power supply 2576 and the at least one additional power supply 2580 may supply power from separate capacitor banks 2205. In other embodiments, the at least one primary power supply 2576 and the at least one additional power supply 2580 may provide power via the same capacitor bank 2505. Furthermore, a number of the capacitors 166 included in the capacitor bank 2505 may vary from that shown in FIG. 25.

For example, in at least one embodiment, a single power supply device may have a plurality of outputs which individually provide an amount of power to enable performance of a respective function (e.g., drive the Z-pinch current 2578, drive the residual current 2582, etc.). Such an arrangement may be based on at least two power supplies (e.g., one primary power supply 2576 and one additional power supply 2580) and may allow for additional control of the Z-pinch current 2578 and sheared flow stabilization thereof. In principle, the at least two power supplies may be scaled, charged, and controlled such that the Z-pinch current 2578 and the stabilization thereof may be maintained for commensurate time periods before any of the at least two power supplies prematurely runs short on or out of stored energy.

In certain embodiments, the plasma confinement system 2500 may incorporate a “tapered electrodes” configuration, characterized by broadening a gap between the inner electrode 2560 and the intermediate electrode 2572 by tapering, along the z-axis, the end 2574 of the intermediate electrode 2572 outwards to increase a volume of at least a portion of the acceleration region 2520, e.g., in a direction of the (unsupported) ends 2565 and 2574. In one example, the taper may be between 0 and 15 degrees from a central axis of the plasma confinement system 2500 (e.g., parallel to the z-axis). Such an arrangement may facilitate a transfer of momentum from plasma heated by the residual current 2582 to neutral gas, e.g., along a positive direction of the z-axis, thereby creating and sustaining sheared flow stabilization. The momentum transfer may be described and modeled using methodology applicable to design/optimization of “de Laval nozzles” as known in the field of jet propulsion.

While techniques described herein are discussed in connection with thermonuclear fusion and, for example, harnessing energy production therefrom, the techniques described herein can be used for other purposes, such as heat generation (e.g., for manufacturing utilizing relatively high temperatures) and propulsion. For example, the plasma confinement system 2200 of FIG. 22 or the plasma confinement system 2500 of FIG. 25 may be modified at least by removing the vacuum chamber 2238 or the external vacuum boundary 2570, respectively, and introducing an opening in one end of the outer electrode 2550 to allow fusion products to escape (e.g., parallel to the z-axis). In certain embodiments, a magnetic nozzle (not shown at FIG. 25) may be positioned downstream of the outer electrode 2550, e.g., to the right of the outer electrode 2550 with respect to the z-axis, to collimate the plasma to reduce any exhaust plume divergence.

The plasma confinement system 2500 may include a controller or other computing device 2548, which may include non-transitory memory on which executable instructions may be stored. The executable instructions may be executed by one or more processors of the controller 2548 to perform various functionalities of the plasma confinement system 2500. Accordingly, the executable instructions may include various routines for operation, maintenance, and testing of the plasma confinement system 2500. The controller 2548 may further include a user interface at which an operator of the plasma confinement system 2500 may enter commands or otherwise modify operation of the plasma confinement system 2500. The user interface may include various components for facilitating operator use of the plasma confinement system 2500 and for receiving operator inputs (e.g., requests to generate plasmas for thermonuclear fusion, etc.), such as one or more displays, input devices (e.g., keyboards, touchscreens, computer mice, depressible buttons, mechanical switches or other mechanical actuators, etc.), lights, etc. The controller 2548 may be communicably coupled to various components (e.g., valves, power supplies, etc.) of the plasma confinement system 2500 to command actuation and use thereof (wired and/or wireless communication paths between the controller 2548 and the various components are omitted from FIG. 25 for clarity).

Referring now to FIG. 26, a block diagram of a method 2600 for operating a plasma confinement system, such as any of the plasma confinement systems described in detail above with reference to FIGS. 22-25, is shown in accordance with at least one embodiment. In certain embodiments, systems and components described in detail herein with reference to FIGS. 22-25 can perform part or all of the method 2600 or be integrated into the method 2600. Accordingly, in such embodiments, the plasma confinement system to be operated as described in detail below may include one or more, or all, components from any of the plasma confinement systems 2200 or 2500. Accordingly, in certain embodiments, the plasma confinement system to be operated may be configured as a Z-pinch plasma confinement system. In an example embodiment, operation of the plasma confinement system (e.g., the plasma confinement system 2200 or the plasma confinement system 2500) by performing the method 2600 may include initiating and driving a sheared ion velocity flow therein for stabilization of Z-pinch discharge.

In some embodiments, the method 2600, or a portion thereof, may be implemented as executable instructions stored in non-transitory memory of a computing device, e.g., the controller 2248 of FIG. 22 or the controller 2548 of FIG. 25, such as a controller communicably coupled to the plasma confinement system. Moreover, in certain embodiments, additional or alternative sequences of steps may be implemented as executable instructions on such a computing device, where individual steps discussed with reference to the method 2600 may be added, removed, substituted, modified, or interchanged.

At block 2602, the method 2600 may include receiving, or generating, a request, at the plasma confinement system, to generate a plasma, according to which an initialization phase of the plasma confinement system may be initiated. In an example embodiment, the request may be generated responsive to receiving a user input, e.g., from an operator of the plasma confinement system. For instance, initialization of the plasma confinement system may be triggered or otherwise initiated via an operator interacting with a user interface, e.g., a push button switch, toggle switch, or other mechanical actuator, a keyboard, a touchscreen, a cursor input, etc.

At block 2604, the method 2600 may include initiating a plasma generation phase of the plasma confinement system, e.g., following the initialization phase. Specifically, in an example embodiment, the plasma generation phase may be initiated at least by powering up the plasma confinement system (e.g., one or more power supplies may supply power to various components utilized during the plasma generation phase) and providing fuel gas for forming a plasma to the plasma confinement chamber, via one or more injectors or other gas valves (e.g., the one or more first valves 2206 and/or the one or more second valves 2212 of FIG. 22), to an acceleration region (e.g., the acceleration region 2210 of FIG. 22) of a plasma confinement chamber of the plasma confinement system. In an example embodiment, the fuel gas is a neutral gas species and/or a pre-ionized gas species that is to be confined as a plasma in an assembly region (e.g., the assembly region 2226 of FIG. 22) of the plasma confinement chamber during the plasma generation phase. In an example embodiment, the fuel gas may be provided to the acceleration region at least by increasing one or more valve openings (e.g., proportional to an applied voltage) of the one or more injectors or other gas valves.

At block 2606, the method 2600 may include generating the plasma in the plasma confinement chamber, e.g., during the plasma generation phase. In an example embodiment, one or more discharge currents, such as a Z-pinch discharge current, may be applied at a repetition rate between a pair of electrodes to generate the plasma. In certain embodiments, the Z-pinch discharge current may be applied and stabilized by a sheared ion velocity flow created and maintained via an applied residual current (e.g., between one electrode of the pair of electrodes and a third, intermediate electrode).

At block 2608, the method 2600 may include determining whether to shut down the plasma confinement system, e.g., according to a request received by, or generated at, the plasma confinement system. If no shut down is indicated, the method 2600 may return to the block 2606 to continue the plasma generation phase, e.g., at least by generating and sustaining the plasma in the plasma confinement chamber.

If shut down is indicated, the method 2600 may proceed to block 2610, where the method 2600 may include shutting down the plasma confinement system (e.g., ending the plasma generation phase). Specifically, generation of the one or more discharge currents may cease such that the plasma may become unsustainable, for example, by decreasing or altogether closing the one or more valve openings of the one or more fuel injectors or other gas valves to reduce or cease supplying the fuel gas to the plasma confinement chamber.

It should be noted that power for executing the plasma generation phase (e.g., at the blocks 2604, 2606, and 2608) may be drawn from one or more capacitors of a capacitor bank conductively coupled to the electrodes. In certain embodiments, the one or more capacitors may be fully (or substantially fully) impregnated with a purified impregnation fluid, such as an oil or a dielectric.

In at least one embodiment, the plasma confinement systems described herein (e.g., the plasma confinement system 2200 or the plasma confinement system 2500) may be a Z-pinch plasma confinement system. In Z-pinch plasma confinement, the applied magnetic field may compress the fuel gas along an axis (e.g., a linear axis denoted by z, hence “Z”-pinch) so as to confine, stabilize, and maintain the plasma. In additional or alternative embodiments, the magnetic field may be stabilized throughout the plasma generation phase by a sheared ion velocity flow driven by the discharge current (also referred to herein as a “Z-pinch discharge current” when discussed in the context of Z-pinch plasma confinement), a process sometimes referred to as sheared flow stabilized (SFS) Z-pinch plasma confinement.

Embodiments of the present disclosure can be described in view of the following clauses:

1. A system, comprising:
a reservoir of a purified fluid to be used to impregnate one or more receptacles;
a manifold fluidically coupled to the one or more receptacles and the reservoir, the manifold configured to withstand an internal pressure differential between the reservoir and the manifold that is to cause the purified fluid to infiltrate the manifold; and
a convection oven in which the one or more receptacles and the manifold are located when the one or more receptacles are impregnated with the purified fluid.

2. The system of clause 1, wherein the one or more receptacles are fluidically coupled to the manifold by one or more adaptors, and wherein at least one adaptor of the one or more adaptors include a portion extending vertically above the one or more receptacles.

3. The system of any one of clauses 1 or 2, wherein a head layer of the purified fluid is maintained over an opening of a receptacle of the one or more receptacles when the receptacle is decoupled from the manifold.

4. The system of any one of clauses 1-3, wherein the manifold is to charge the one or more receptacles with the purified fluid when the internal pressure differential is generated, and wherein the internal pressure differential is generated by reducing a pressure in the manifold to below atmospheric pressure.

5. The system of any one of clauses 1-4, wherein the manifold is pressurized to a pressure of up to 80 psi while the one or more receptacles are impregnated with the purified fluid.

6. The system of any one of clauses 1-5, wherein a head layer of the purified fluid is maintained over an opening of a receptacle of the one or more receptacles while the receptacle is cooled after being impregnated with the purified fluid.

7. The system of any one of clauses 1-6, wherein the one or more receptacles are heated prior to or while being charged with the purified fluid, and wherein the one or more receptacles are cooled after being filled with the purified fluid.

8. The system of any one of clauses 1-7, wherein, prior to being impregnated with the purified fluid, the one or more receptacles are evacuated by exposing one or more internal volumes of the one or more receptacles to a pressure lower than atmospheric pressure conveyed through the manifold while the one or more receptacles are heated externally by convective heating.

9. A system for assembling one or more capacitors, the system comprising:
a first subsystem to purify a fluid to be used to impregnate the one or more capacitors; and
a second subsystem to receive the fluid from the first subsystem and to impregnate the one or more capacitors with the fluid via a manifold configured to withstand an internal pressure differential sufficient to cause the fluid to infiltrate the manifold from the first subsystem, wherein the manifold and the one or more capacitors are positioned within a convection oven.

10. The system of clause 9, wherein the first subsystem comprises a reservoir that is to receive the fluid prior to purification, and wherein the fluid is to be purified by cycling the fluid through one or more filters that are fluidically coupled to the reservoir and by heating the reservoir while the reservoir is fluidically coupled to a vacuum generated by a pump assembly.

11. The system of any one of clauses 9 or 10, wherein the first subsystem comprises a second reservoir that is to receive the fluid from a first reservoir after the fluid is purified, and wherein the fluid is to be transferred from the first reservoir to the second reservoir by a second internal pressure differential generated between the first reservoir and the second reservoir.

12. The system of clause 11, wherein the fluid is to be transferred from the second reservoir of the first subsystem to the one or more capacitors by conveying a vacuum, through the manifold, to an internal volume of the one or more capacitors to generate the internal pressure differential between the second reservoir and the one or more capacitors, and wherein the fluid is to flow into the one or more capacitors based, at least in part, on the internal pressure differential generated between the second reservoir and the one or more capacitors.

13. The system of any one of clauses 9-12, wherein a capacitor of the one or more capacitors is positioned below the manifold and coupled to the manifold by an adaptor, and wherein the adaptor comprises a first piping section extending above the capacitor and a second piping section located above the manifold and extending to the first piping section.

14. The system of any one of clauses 9-13, wherein the one or more capacitors are to be used to supply power to a plasma confinement system.

15. The system of any one of clauses 9-14, wherein a capacitor of the one or more capacitors comprises a fitting having a first set of threading disposed along an outer surface of the fitting and a second set of threading disposed along an inner surface of the fitting, wherein an adaptor engages with the first set of threading when the capacitor is coupled to the manifold, and wherein a threaded cap engages with the second set of threading when the capacitor is sealed.

16. A method, comprising:
coupling one or more receptacles to a manifold;
impregnating the one or more receptacles with a fluid by varying internal pressure at the manifold; and
sealing the one or more receptacles while the one or more receptacles remain coupled to the manifold.

17. The method of clause 16, wherein varying the internal pressure at the manifold comprises activating one or more valves to convey one of a higher pressure generated by a gas supply or a lower pressure generated by a pump assembly.

18. The method of any one of clauses 16 or 17, wherein impregnating the one or more receptacles with the fluid comprises maintaining a positive pressure of the fluid flowing to the one or more receptacles while the one or more receptacles are cooled by convective cooling.

19. The method of any one of clauses 16-18, wherein sealing the one or more receptacles includes inserting a cap through an adaptor coupling a receptacle of the one or more receptacles to the manifold and coupling the cap to a double-threaded fitting of the receptacle.

20 The method of any one of clauses 16-19, wherein sealing the one or more receptacles includes coupling a cap to a double-threaded fitting of a receptacle of the one or more receptacles while the double-threaded fitting is submerged in the fluid.

21. A system, comprising:
a capacitor, comprising:
   a capacitor body at least partially enclosing an interior volume impregnated with a purified fluid;
   a cover coupled to the capacitor body;
   a fitting coupled to the cover and protruding away from the interior volume, the fitting comprising a first set of threading disposed at an outer surface of the fitting and a second set of threading disposed at an inner surface of the fitting; and
   a threaded cap coupled to the fitting.

22. The system of clause 21, wherein the fitting is cylindrical and comprises a bore extending through the fitting along a longitudinal axis thereof.

23. The system of any one of clauses 21 or 22, wherein the fitting comprises a first portion that is embedded in the cover and a second portion that extends away from the cover.

24. The system of any one of clauses 21-23, wherein the first set of threading is configured to engage with an adaptor to be used to couple the capacitor to a manifold.

25. The system of any one of clauses 21-24, wherein the second set of threading is configured to engage with a threading of the threaded cap.

26. The system of any one of clauses 21-25, wherein the threaded cap is to be coupled to the second set of threading while the first set of threading is coupled to an adaptor.

27. The system of any one of clauses 21-26, wherein the system is a plasma confinement system, the capacitor usable to supply power to the plasma confinement system.

The specification and drawings are to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors—for example, in an embodiment, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

1. A system, comprising:
a reservoir of a purified fluid to be used to impregnate one or more receptacles;
a manifold fluidically coupled to the one or more receptacles and the reservoir, the manifold configured to withstand an internal pressure differential between the reservoir and the manifold that is to cause the purified fluid to infiltrate the manifold; and
a convection oven in which the one or more receptacles and the manifold are located when the one or more receptacles are impregnated with the purified fluid.

2. The system of claim 1, wherein the one or more receptacles are fluidically coupled to the manifold by one or more adaptors, and wherein at least one adaptor of the one or more adaptors include a portion extending vertically above the one or more receptacles.

3. The system of claim 1, wherein a head layer of the purified fluid is maintained over an opening of a receptacle of the one or more receptacles when the receptacle is decoupled from the manifold.

4. The system of claim 1, wherein the manifold is to charge the one or more receptacles with the purified fluid when the internal pressure differential is generated, and wherein the internal pressure differential is generated by reducing a pressure in the manifold to below atmospheric pressure.

5. The system of claim 1, wherein the manifold is pressurized to a pressure of up to 80 psi while the one or more receptacles are impregnated with the purified fluid.

6. The system of claim 1, wherein a head layer of the purified fluid is maintained over an opening of a receptacle of the one or more receptacles while the receptacle is cooled after being impregnated with the purified fluid.

7. The system of claim 1, wherein the one or more receptacles are heated prior to or while being charged with the purified fluid, and wherein the one or more receptacles are cooled after being filled with the purified fluid.

8. The system of claim 1, wherein, prior to being impregnated with the purified fluid, the one or more receptacles are evacuated by exposing one or more internal volumes of the one or more receptacles to a pressure lower than atmospheric pressure conveyed through the manifold while the one or more receptacles are heated externally by convective heating.

9. A system for assembling one or more capacitors, the system comprising:
a first subsystem to purify a fluid to be used to impregnate the one or more capacitors; and
a second subsystem to receive the fluid from the first subsystem and to impregnate the one or more capacitors with the fluid via a manifold configured to withstand an internal pressure differential sufficient to cause the fluid to infiltrate the manifold from the first subsystem, wherein the manifold and the one or more capacitors are positioned within a convection oven.

10. The system of claim 9, wherein the first subsystem comprises a reservoir that is to receive the fluid prior to purification, and wherein the fluid is to be purified by cycling the fluid through one or more filters that are fluidically coupled to the reservoir and by heating the reservoir while the reservoir is fluidically coupled to a vacuum generated by a pump assembly.

11. The system of claim 9, wherein the first subsystem comprises a second reservoir that is to receive the fluid from a first reservoir after the fluid is purified, and wherein the fluid is to be transferred from the first reservoir to the second reservoir by a second internal pressure differential generated between the first reservoir and the second reservoir.

12. The system of claim 11, wherein the fluid is to be transferred from the second reservoir of the first subsystem to the one or more capacitors by conveying a vacuum, through the manifold, to an internal volume of the one or more capacitors to generate the internal pressure differential between the second reservoir and the one or more capacitors, and wherein the fluid is to flow into the one or more capacitors based, at least in part, on the internal pressure differential generated between the second reservoir and the one or more capacitors.

13. The system of claim 9, wherein a capacitor of the one or more capacitors is positioned below the manifold and coupled to the manifold by an adaptor, and wherein the adaptor comprises a first piping section extending above the capacitor and a second piping section located above the manifold and extending to the first piping section.

14. The system of claim 9, wherein the one or more capacitors are to be used to supply power to a plasma confinement system.

15. The system of claim 9, wherein a capacitor of the one or more capacitors comprises a fitting having a first set of threading disposed along an outer surface of the fitting and a second set of threading disposed along an inner surface of the fitting, wherein an adaptor engages with the first set of threading when the capacitor is coupled to the manifold, and wherein a threaded cap engages with the second set of threading when the capacitor is sealed.

16. A method, comprising:
coupling one or more receptacles to a manifold;
impregnating the one or more receptacles with a fluid by varying internal pressure at the manifold; and
sealing the one or more receptacles while the one or more receptacles remain coupled to the manifold.

17. The method of claim 16, wherein varying the internal pressure at the manifold comprises activating one or more valves to convey one of a higher pressure generated by a gas supply or a lower pressure generated by a pump assembly.

18. The method of claim 16, wherein impregnating the one or more receptacles with the fluid comprises maintaining a positive pressure of the fluid flowing to the one or more receptacles while the one or more receptacles are cooled by convective cooling.

19. The method of claim 16, wherein sealing the one or more receptacles includes inserting a cap through an adaptor coupling a receptacle of the one or more receptacles to the manifold and coupling the cap to a double-threaded fitting of the receptacle.

20. The method of claim 16, wherein sealing the one or more receptacles includes coupling a cap to a double-threaded fitting of a receptacle of the one or more receptacles while the double-threaded fitting is submerged in the fluid.
